(19) United States
(12) Patent Application Publication
(10) Pub. No.: US 2008/0049574 A1
(43) Pub. Date: Feb. 28, 2008

(54) Data Processor

(76) Inventor: Hiroshi Yahata, Osaka (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 11/574,821

(22) PCT Filed: Sep. 13, 2005
(86) PCT No.: PCT/JP05/16815

§ 371 Date: Mar. 7, 2007

(30) Foreign Application Priority Data
Sep. 13, 2004 (JP) 2004-265103

(51) Int. Cl. G11B 27/00

(52) U.S. Cl. 369/47.13

(57) ABSTRACT

To provide a method of managing data in a situation where audio and video data, acquired by a single video recording session, has been split into multiple files.

A data processor writes a data stream, representing video, and management information for playing back the video based on the data stream on at least one storage medium. In the data stream, picture data of respective pictures forming the video and time information, showing presentation times of the respective pictures, are stored in association with each other. The data processor includes: a processor for generating, as the management information, a table that associates the time information, storage locations of the picture data in the data stream, and file information identifying a stream file to store the picture data with each other for one or more pictures; and a controller for writing the data stream and the management information as one or more stream files and as one or more management information files, respectively, on the storage medium.

### TECHNICAL FIELD

The present invention relates to a technique of writing moving picture data on a storage medium and managing the moving picture data stored there.

### BACKGROUND ART

Recently, optical disk recorders for writing and storing digital data on an optical disk such as a DVD have become more and more popular. The targets of recording include a data stream representing a broadcast program and video and audio data streams that have been captured using a camcorder, for example. The data written is saved in a randomly accessible state on a DVD.

DVDs adopt a file system called “UDF (universal disc format)”. The UDF file system is suitable for reading, writing and editing video/audio data. For example, as the size of video/audio data to be written mainly on a DVD is large, the maximum file size according to the UDF file system is defined to be sufficiently large. Also, according to the UDF file system, data can be edited on a sector-by-sector basis. Patent Document No. 1 discloses such a UDF file system.

To write video/audio data on randomly accessible storage media such as DVDs, appropriate file systems have been developed, and utility and a sufficient degree of installability have been guaranteed, so far in view of the properties of the data to be written.

Patent Document No. 1: Japanese Patent Application Laid-Open Publication No. 2000-013728

### DISCLOSURE OF INVENTION

### Problems to be Solved by the Invention

As a technique of editing video/audio data using a PC (which is called “nonlinear editing (NLE)”) has become increasingly popular recently, it becomes more and more necessary to store and manage video/audio data so as to make that data editable with a PC's file system.

PCs usually adopt the FAT 32 file system. According to the FAT 32 file system, the size of a single data file is limited to less than 4 GB. That is why considering that the data will be edited with the FAT 32 file system, the video/audio data obtained by a single video recording session needs to be split into multiple files to be stored separately. Then it is important how to manage the video/audio data in those files.

Especially as various devices (such as camcorders) that can be loaded with a number of different storage media, including a hard disk with a small diameter and a semiconductor memory, at the same time have been developed recently, those split video/audio data may be stored in multiple storage media separately. For that reason, not only when video/audio data has been split and stored on a single storage medium but also when those split data are stored on multiple different storage media, the video/audio data need to be managed appropriately.

An object of the present invention is to provide a method of managing data in a situation where video/audio data, obtained by a single video recording session, has been split into multiple files.

### Means for Solving the Problems

A data processor according to the present invention writes a data stream, representing video, and management information for playing back the video based on the data stream on at least one storage medium. In the data stream, picture data of respective pictures forming the video and time information, showing presentation times of the respective pictures, are stored in association with each other. The data processor includes: a processor for generating, as the management information, a table that associates the time information, storage locations of the picture data in the data stream, and file information identifying a stream file to store the picture data with each other for one or more pictures; and a controller for writing the data stream and the management information as one or more stream files and as one or more management information files, respectively, on the storage medium.

The controller may generate a plurality of stream files and one management information file.

The data stream may include at least one playback unit beginning with base picture data of a base picture that is decodable by itself, and the processor may generate the table for the base picture data at the top of the playback unit.

The processor may generate the table for the base picture data that is arranged at the top of each of the stream files.

The data stream may include the time information that has been generated with respect to a common reference time for the video that has been recorded continuously, and the controller may split the data stream that has been generated with respect to the common reference time, thereby generating a plurality of stream files.

The data stream may be made up of a plurality of packets, each having a constant data length, and the processor may find the storage location of the picture data by reference to the arrangement of the packets in the data stream.

The controller may write the one or more stream files and the one or more management information files on the storage medium that adopts FAT 32 file system.

The data processor may further include an encoder for generating the at least one playback unit based on an analog signal.

The data processor may further include an encoder for generating the data stream with respect to the common reference time when video is recorded continuously based on an analog signal. A storage medium according to the present invention has stored thereon one or more stream files, including a data stream representing video, and one or more management information files, including management information for playing back the video based on the data stream. In the data stream, picture data of respective pictures forming the video and time information, showing presentation times of the respective pictures, are stored in association with each other. In the management information, stored is a table that associates the time information, storage locations of the picture data in the data stream, and file information identifying the stream file to store the picture data with each other for one or more pictures.

### EFFECTS OF THE INVENTION

A data processor according to the present invention generates a table storing file information that identifies a file storing a data stream. By reference to this table, it is possible to know in what file part of all of the data stream is stored without analyzing the data stream. Thus, any desired playback point of the data stream can be accessed quickly.

### BRIEF DESCRIPTION OF DRAWINGS

FIG. 1 shows a configuration for a system that is made up of an optical disk recorder 100 according to a preferred embodiment of the present invention and other devices.

FIG. 2 shows the data structure of a transport stream (TS) 20.

FIG. 3(a) shows the data structure of a video TS packet 30 and FIG. 3(b) shows the data structure of an audio TS packet 31.

Portions (a) to (d) of FIG. 4 show the makeup of a stream when video pictures are played back from video TS packets.

FIG. 5 shows an arrangement of functional blocks in the recorder 100.

FIG. 6 shows a detailed arrangement of functional blocks in the TS processing section 204.

Portions (a) through (e) of FIG. 7 show a correlation between a transport stream and a clip AV stream.

FIG. 8 shows a storage area on the BD 205a and its directory/file structure.

Portions (a) through (d) of FIG. 9 show a relationship between the management information and the stream data.

FIG. 10 shows the information (entries) stored in the playlist file 83 and its data structure.

FIG. 11 shows the data structures of the information (entries) stored in the clip information file 84 and some entries in the clip information file.

FIG. 12 shows the data structures of the information (entries) stored in the clip information file 84 and other entries in the clip information file.

FIG. 13 shows the data structure of a time/address conversion table.

FIG. 14 shows a first exemplary time/address correlation.

FIG. 15 shows a second exemplary time/address correlation.

Portion (a) of FIG. 16 shows real playlists Nos. 1 and 2 with their associated Clips Nos. 1 and 2 and portion (b) of FIG. 16 shows a virtual playlist for playing back a first interval from IN1 through OUT1 and a second interval from IN2 through OUT2 continuously.

Portion (a) of FIG. 17 shows the location of a splitting point for splitting the virtual playlist and portion (b) of FIG. 17 shows virtual playlists Nos. 1 and 2 that have been split.

Portion (a) of FIG. 18 shows virtual playlists Nos. 1 and 2 to be combined together and portion (b) of FIG. 18 shows the combined virtual playlist.

FIG. 19(a) shows a real playlist and a clip, from which an interval A-B should be deleted, while FIG. 19(b) shows a real playlist and a clip, from which the interval A-B has been deleted and in which the points A and B have been combined together.

FIG. 20 shows a correlation between thumbnail pictures to be managed on the BD 205a and a management file.

Portions (a) through (c) of FIG. 21 respectively show a virtual playlist 312, a real playlist 314 and a clip 316, to each of which a mark has been added.

Portions (a) through (d) of FIG. 22 show a file arrangement according to a file system that has a maximum permissible file size.

Portions (a) and (b) of FIG. 23 show a correlation between streams, from which an intermediate portion is deleted, and the sequence.

Portions (a) through (d) of FIG. 24 show a correlation between the management information files 82 to 84, preferably used in the FAT 32 file system, and the clip AV stream file 85 according to this preferred embodiment.

FIG. 25 schematically shows the data structure of the time-address conversion table EP_MAP 87.

FIG. 26 shows the detailed data structure of the conversion table 87.

FIG. 27 is a flowchart showing the procedure of playing back a picture associated with a PTS that has been specified using the conversion table 87.

Portions (a) and (b) of FIG. 28 show a clip yet to be edited and an edited clip, respectively, according to this preferred embodiment.

Portion (a) of FIG. 29 shows the concept of the time-address conversion table that is stored in a single clip information file with respect to the clip AV streams edited; portion (b) of FIG. 29 shows the respective ranges of two STC sequences; portion (c) of FIG. 29 shows two files in which the clip AV streams are stored; and portion (d) of FIG. 29 shows how the ATS values of the clip AV stream change in multiple files.

FIG. 30 shows a correlation between fine entries and I-pictures located at the respective tops of GOPs.

FIG. 31(a) through 31(d) show modified data structures of the fine entries.

FIG. 32 shows the data structure of a time map according to this preferred embodiment.

Portion (a) of FIG. 33 shows the concept of a single content according to this preferred embodiment, portion (b) of FIG. 33 shows the concept of clips, each including the content's management information and stream data, and portion (c) of FIG. 33 shows three memory cards 112a, 112b and 112c.

FIG. 34 shows the contents of information included in the clip meta-data 331.

### DESCRIPTION OF REFERENCE NUMERALS

100 BD recorder with built-in HDD
106 TV
108 PC
112 memory card
114 BD
201a digital tuner
201b analog tuner
202 A/D converter
203 MPEG-2 encoder
204 TS processing section
205a BD
205b HDD
206 MPEG-2 decoder
207 graphic control section
208 memory
209 D/A converter
210 program ROM
211 CPU
212 RAM
213 CPU bus
214 network control section
215 instruction receiving section
216 interface (I/F) section
217 memory card control section
250 system control section
261 source packetizer
262 clock counter
263 PLL circuit
264 buffer
265 source depacketizer

### MODE FOR CARRYING OUT THE INVENTION

Hereinafter, preferred embodiments of a data processor according to the present invention will be described with reference to the accompanying drawings. In the following description, the data processor is supposed to be an optical disk recorder with a built-in HDD and drives and slots for optical disks, semiconductor memories and small-sized HDDs. However, the present invention is in no way limited to those specific preferred embodiments but the data processor may also be a camcorder or a cellphone with a movie shooting function, for example.

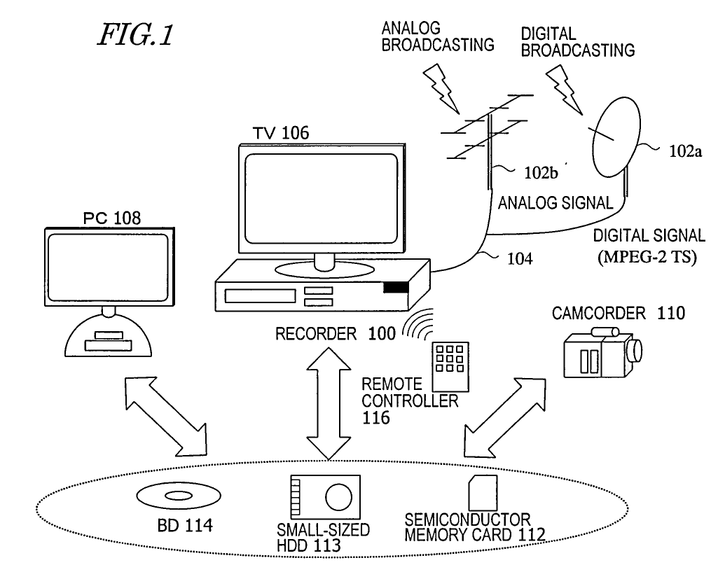

FIG. 1 illustrates a configuration for a system that is made up of an optical disk recorder 100 and other devices. The optical disk recorder 100 (which will be simply referred to herein as a “recorder 100”) has a recording function, i.e., can record a moving picture data stream representing the video and audio of a broadcast program on one or more types of storage media. Examples of the storage media include a semiconductor memory card 112, a memory card 113 using a small-sized HDD, and a Blu-ray Disc (BD) 114. These are examples of removable storage media. But if the recorder 100 has a built-in HDD, the moving picture data stream can also be recorded and stored on the HDD. The recorder 100 also has a playback function, i.e., can read the data stream that has been recorded on any of these storage media and present the moving picture.

FIG. 1 shows other devices (including a PC 108 and a camcorder 110) that can operate in conjunction with the recorder 100 to execute its recording and playback functions. Each of those other devices also has its own recording and playback functions, which are similar to those of the recorder 100. The following description will be focused on the recorder 100.

The recorder 100 performs its recording and playback functions in response to an instruction that has been given by the user through a button (not shown) on the body of the recorder 100, for example.

First, the processing to be done by the recorder 100 to execute its recording function will be described. The recorder 100 is connected to an antenna 102a that receives a digital signal representing a digital broadcast program and to an antenna 102b that receives an analog signal representing an analog broadcast program, and receives a digital signal and an analog signal. The recorder 100 may receive the digital signal and the analog signal through a coaxial cable 104, for example.

The digital signal has been transmitted as an MPEG-2 transport stream (which will be simply referred to herein as a “transport stream” or a “TS”). On receiving the TS, the recorder 100 performs predetermined processing on the TS and then records it on the BD 114 while maintaining its TS packet structure to be described later. On receiving an analog signal, the recorder 100 extracts moving picture data from the analog signal and compresses and encodes the data, thereby generating a TS and recording the TS on the BD 114. The recorder 100 can also record the analog or digital broadcast program on a semiconductor memory card 112 such as an SD memory card or a memory card 113 that uses a small-sized HDD. The recorder 100 can also copy the still picture data, stored on the memory card 112 or 113, to the BD 114. When a recording operation is performed using the camcorder 110, the camcorder 110 generates a TS based on analog signals representing video and audio to be captured.

Next, the processing to be done by the recorder 100 to execute its playback function will be described. The recorder 100 decodes the audio and video that has been recorded on the BD 114 and reproduces the data on a TV 106 and through loudspeakers (not shown). The video and audio do not have to be those of a broadcast program but may also have been captured using the camcorder 110, for example. It should be noted that the device that recorded the video and/or audio could be different from a device that plays them back. For example, the BD 114 on which video and audio has been recorded may be removed from the recorder 100 and loaded into another device such as the PC 108 or the camcorder 110. And the device loaded with the BD 114 may play back the video and audio.

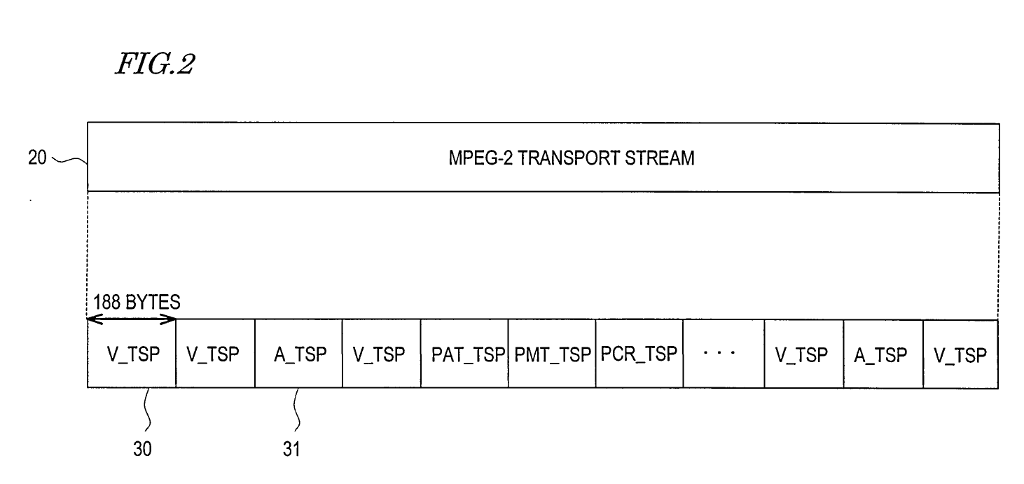

Hereinafter, the data structure of a transport stream to be transmitted as a digital broadcast signal will be described with reference to FIGS. 2 to 4.

FIG. 2 shows the data structure of a transport stream (TS) 20. Examples of TS packets include a video TS packet (V_TSP) 30 in which compressed video data is stored, an audio TS packet (A_TSP) 31 in which compressed audio data is stored, a packet (PAT_TSP) in which a program association table (PAT) is stored, a packet (PMT_TSP) in which a program map table (PMT) is stored, and a packet (PCR_TSP) in which a program clock reference (PCR) is stored. Each of these TS packets has a data size of 188 bytes. The TS packets describing the program formation, including PAT_TSP and PMT_TSP, are generally called “PSI/SI packets”.

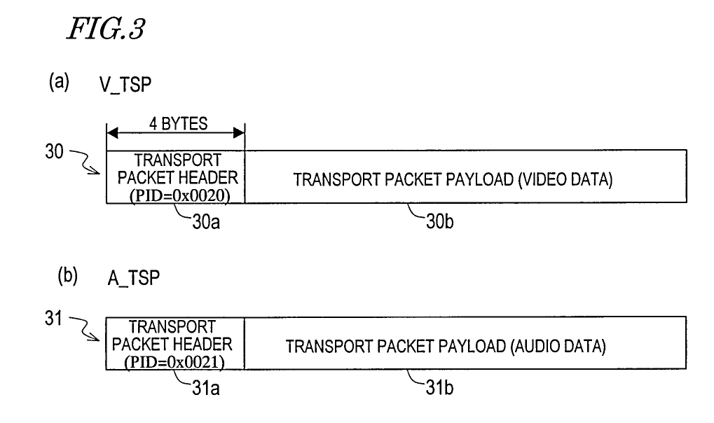

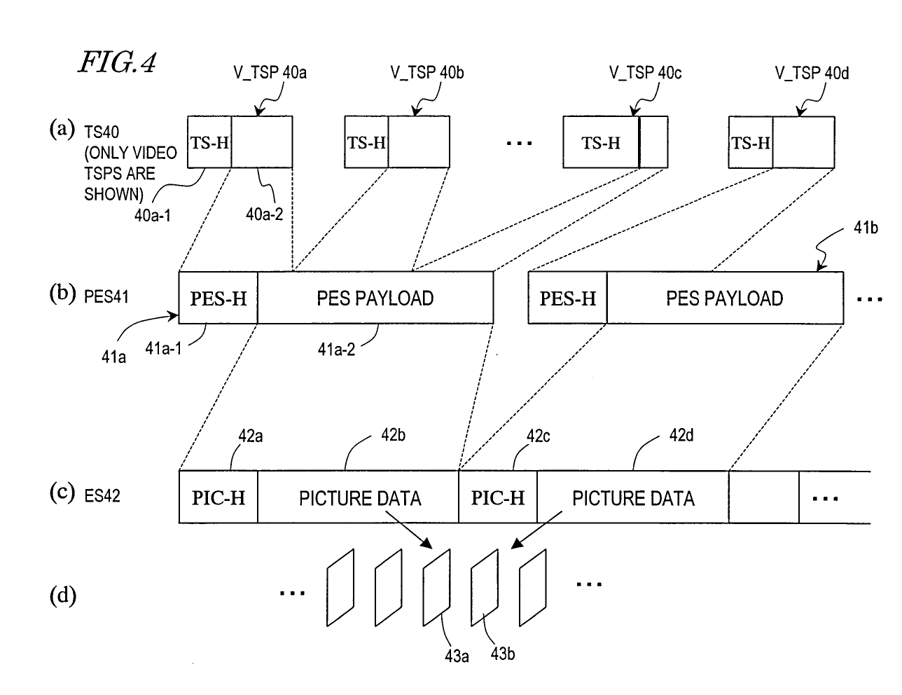

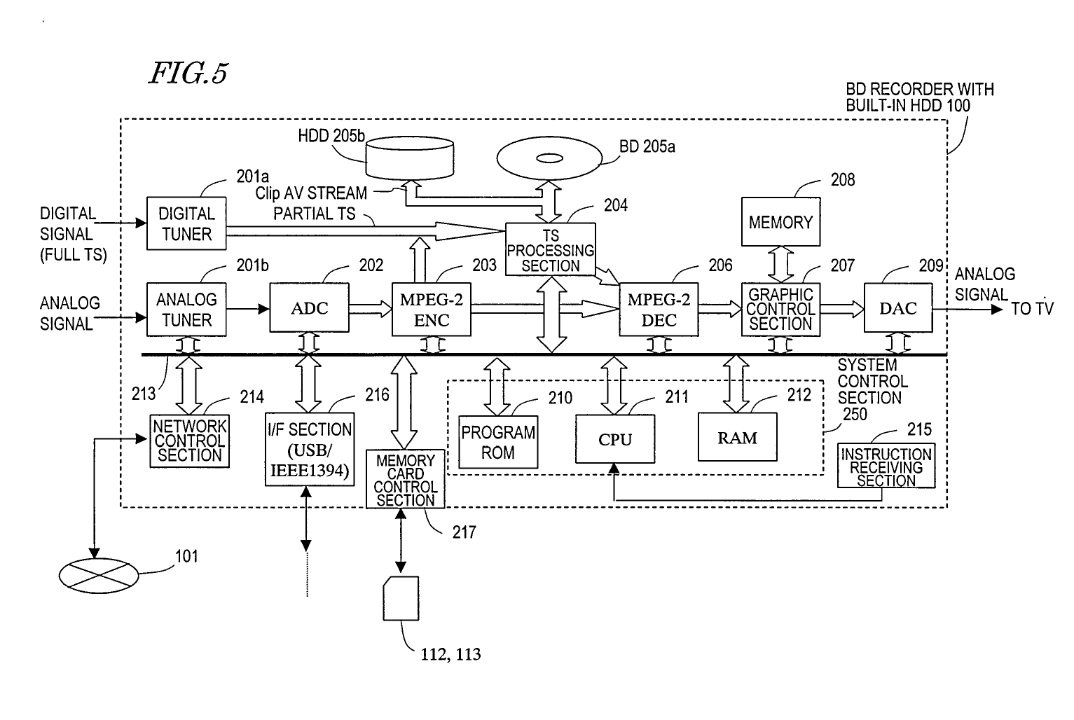

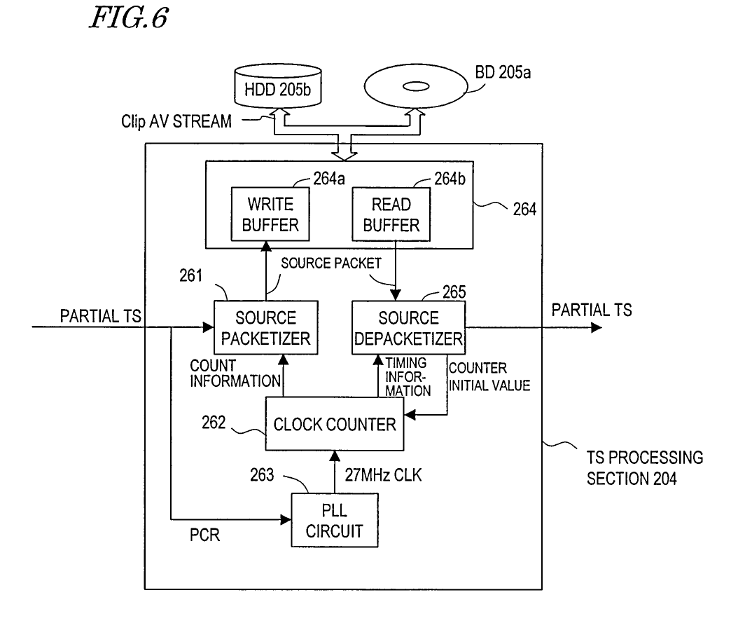

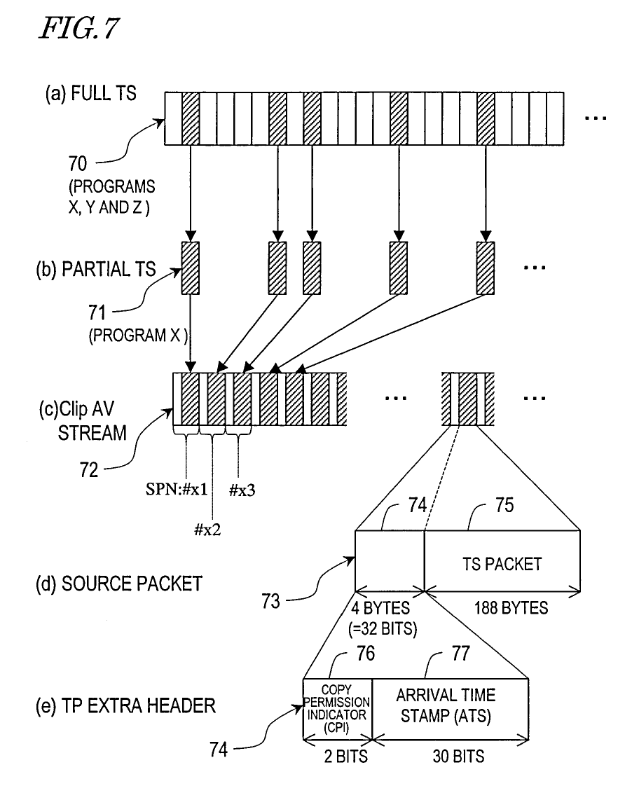

Hereinafter, the video TS packets and audio TS packets relating to the processing of the present invention will be described. FIG. 3(a) shows the data structure of a video TS packet 30. The video TS packet 30 includes a transport packet header 30a of 4 bytes and a transport packet payload 30b of 184 bytes. Video data 30b is stored in the payload 30b. On the other hand, FIG. 3(b) shows the data structure of an audio TS packet 31. The audio TS packet 31 also includes a transport packet header 31a of 4 bytes and a transport packet payload 31b of 184 bytes. Audio data 31b is stored in the transport packet payload 31b.

As can be seen from this example, a TS packet usually consists of a transport packet header of 4 bytes and elementary data of 184 bytes. In the packet header, a packet identifier (PID) showing the type of that packet is described. For example, the PID of a video TS packet is 0x0020, while that of an audio TS packet is 0x0021. The elementary data may be content data such as video data or audio data or control data for controlling playback. The type of data stored there changes according to the type of the packet.

Hereinafter, a correlation between video data and pictures that make up the video will be described as an example. Portions (a) to (d) of FIG. 4 show the makeup of a stream when video pictures are played back from video TS packets. As shown in portion (a) of FIG. 4, this TS 40 includes video TS packets 40a through 40d. Although the TS 40 may include other packets, only those video TS packets are shown here. A video TS packet can be easily identifiable by the PID stored in its header 40a-1.

A packetized elementary stream packet is made up of the video data of respective video TS packets such as the video data 40a-2. Portion (b) of FIG. 4 shows the data structure of a packetized elementary stream (PES) 41. The PES 41 includes a plurality of PES packets 41a, 41b, etc. The PES packet 41a is made up of a PES header 41a-1 and a PES payload 41a-2. These data are stored as the video data of the video TS packets.

Each PES payload 41a-2 includes the data of a single picture. A presentation time stamp (PTS) representing the presentation time of each picture is stored in the PES header 41a-1.

An elementary stream is made up of those PES payloads 41a-2. Portion (c) of FIG. 4 shows the data structure of an elementary stream (ES) 42. The ES 42 includes multiple pairs of picture headers and picture data. It should be noted that the “picture” is generally used as a term that may refer to either a frame or a field.

In the picture header 42a shown in portion (c) of FIG. 4, a picture coding type, showing the picture type of the following picture data 42b, is described. In the same way, a picture coding type, showing the picture type of the following picture data 42d, is described in the picture header 42c. The “type” is one of an I-picture (intra-coded picture), a P-picture (predictive-coded picture) and a B-picture (bidirectionally-predictive-coded picture). If the type shows this is an I-picture, its picture coding type may be “001b” if it is an MPEG-2 video, for example.

The picture data 42b, 42d, etc. is data corresponding to a single frame, which may consist of either that data only or that data and preceding/succeeding data to be decoded before and/or after the former data. For example, portion (d) of FIG. 4 shows a picture 43a consisting of the picture data 42b and a picture 43b consisting of the picture data 42d.

In playing back video based on a TS, the MPEG-2 decoder 206 (to be described later) of the recorder 100 gets video TS packets, extracts picture data through the processing described above, decodes the data, and thereby gets pictures that form the video. As a result, the video can be presented on the TV 106. Conversely, in recording video, the MPEG-2 encoder 203 (to be described later) of the recorder 100 forms a TS 40 by performing its processing steps in the order of portions (d), (c), (b) and (a) of FIG. 4.

Next, the hardware configuration of the device will be described with reference to FIG. 5. In the following example, the recorder 100 will be described as an example. However, the same statement also applies to the PC 108 and the camcorder 110 shown in FIG. 1. The camcorder 110 may include no digital tuner 201a to be described later.

Hereinafter, the configuration of the recorder 100 of this preferred embodiment will be described with reference to FIG. 5, which shows an arrangement of functional blocks in the recorder 100. The recorder 100 includes not only the BD 205a but also a hard disk drive (HDD) 205b as storage media. That is to say, the recorder 100 is a BD recorder with the built-in HDD 205b.

The recorder 100 includes a digital tuner 201a, an analog tuner 201b, an A/D converter 202, an MPEG-2 encoder 203, a TS processing section 204, an MPEG-2 decoder 206, a graphic control section 207, a memory 208, a D/A converter 209, a CPU bus 213, a network control section 214, an instruction receiving section 215, an interface (I/F) section 216, a memory card control section 217 and a system control section 250. In FIG. 5, the optical disk 205a is shown within the recorder 100. However, the optical disk 205a is removable from the optical disk recorder 100 and is not an integral part of the recorder 100 itself.

Hereinafter, the functions of these components will be described one by one. The digital tuner 201a receives a digital signal, including at least one program, from the antenna 102a (see FIG. 1). The transport stream to be transmitted as the digital signal includes packets representing a plurality of programs. Such a transport stream including packets representing a plurality of programs will be referred to herein as a “full TS”. The digital tuner 201a tunes itself to a particular channel, extracts only packets representing a requested program, and then outputs it as a “partial TS”.

The packets on a desired channel may be extracted from the full TS in the following manner. Suppose the program number (or channel number) of the designated program is X. In that case, first, the full TS is searched for the program association table packet (i.e., PAT_TSP shown in FIG. 2). The packet ID (PID) of the program association table packet is always zero. Thus, a packet having that value may be searched for. In the program association table in the program association table packet, respective program numbers and the program map table packet PIDs (i.e., PMT_TSP shown in FIG. 2) of respective programs associated with those program numbers are stored. Thus, the packet ID (PID) of the program map table (PMT) associated with the program number X can be detected. The PID of the program map table PMT is supposed to be XX.

Next, when the program map table packet (i.e., PMT_TSP shown in FIG. 2) with PID=XX is extracted, a program map table PMT associated with the program number X can be obtained. The program map table PMT includes the PIDs of TS packets, in which the video and audio information of each program to watch and listen to is stored on a program-by-program basis. For example, the PID of the video information associated with the program number X may be XV and the PID of the audio information thereof may be XA. By using the PID (=XV) of the packet storing the video information and the PID (=XA) of the packet storing the audio information that have been obtained in this manner, the video and audio packets about a particular program can be extracted from a full TS.

In making a partial TS from a full TS, not only those packets that store the required video and audio information but also program specific information (PSI) packets and service information (SI) packets need to be extracted and corrected. As used herein, the PSI packets collectively refer to the program association table packets (PAT_TSP) and program map table packets (PMT_TSP) shown in FIG. 2. The PSI packets need to be corrected because the full TS and the partial TS include different numbers of programs, and therefore, the program association table and the program map table need to be adapted to the partial TS. The SI packet includes data describing the contents, schedule/timings and so on of the programs included in the full TS and separately defined expansion information (which is also called “program service information”). In the full TS, the SI packet includes as many as 20 to 30 different types of data. Among these types of data, only important data for playing back the partial TS is extracted to generate a single SIT packet and multiplex it in the partial TS. Also, in the partial TS, information indicating that the stream is a partial TS (which is called a “partial transport stream descriptor”) is stored in the SIT packets. It is already a conventional technique to multiplex an SIT packet in a partial TS so as to comply with the European and Japanese digital broadcasting standards (DVB/ARIB).

The analog tuner 201b receives an analog signal from the antenna 102b (see FIG. 1), tunes itself to a particular channel according to the frequency, extracts the signal of a requested program, and then outputs the video and audio signals of the program to the A/D converter 202. In FIG. 1, the recorder 100 receives the digital signal and analog signal through a coaxial cable 104. Therefore, strictly speaking, there is only one signal input system in the example illustrated in FIG. 5. However, since the digital signal and the analog signal can be easily separated from each other according to their frequencies, the digital signal and the analog signal are shown in FIG. 5 as being input through two different systems.

The A/D converter 202 converts the input signals into digital ones and supplies them to the MPEG-2 encoder 203. On receiving an instruction to start recording, the MPEG-2 encoder 203 (which will be simply referred to herein as an “encoder 203”) compresses and encodes the supplied digital data of the analog broadcast into the MPEG-2 format, generates a transport stream and passes it to the TS processing section 204. This is the processing of generating the TS 40 shown in portion (a) of FIG. 4 based on the respective pictures shown in portion (d) of FIG. 4. More specifically, the encoder 203 extracts a digital baseband signal representing the pictures 43a, 43b from the analog broadcast signal, encodes the signal to generate the picture data 42b, and then generates the ES 42 shown in portion (c) of FIG. 4.

The encoder 203 also generates a presentation time stamp (PTS) showing the presentation/output time of the picture (which may be a frame or a field), stores the PTS in the PES header 41a, and generates the PES 41 shown in portion (b) of FIG. 4. Thereafter, the encoder 203 forms the TS 40 shown in portion (a) of FIG. 4. This processing is continued until the encoder 203 receives an instruction to end the recording. To perform the compression coding, the encoder 203 includes a buffer (not shown) for temporarily storing reference pictures and so on.

In recording a moving picture, the TS processing section 204 receives the partial TS, generates a clip AV stream from it, and records the stream on the BD 205a and/or the HDD 205b. The clip AV stream is a data stream, of which the format is suitable for recording it on the BD 205a and/or the HDD 205b. The clip AV stream is made up of a plurality of source packets, which are generated by adding a predetermined header to the respective TS packets that form the partial TS. The processing of generating the clip AV stream will be described more fully later with reference to FIGS. 7(a) through 7(e).

In playing back a moving picture, the TS processing section 204 reads the clip AV stream from the BD 205a and/or the HDD 205b, generates a partial TS from the clip AV stream, and outputs it to the MPEG-2 decoder 206.

Also, the TS processing section 204 may receive still picture data that is stored in a memory card 112 or 113 from a memory card control section 217 to be described later and write the still picture data as it is on the BD 205a and/or the HDD 205b without processing it. Or the TS processing section 204 may also read the still picture data that has been written on the BD 205a and/or the HDD 205b and output it to the decoder 206. A more detailed configuration and operation of the TS processing section 204 will be described more fully later with reference to FIGS. 6 and 7. In this description, the TS processing section 204 is supposed to write data on the BD 205a and/or the HDD 205b and read data from at least one of them just for illustrative purposes. However, the stream is actually written on, or read from, the BD 205a or HDD 205b by controllers (not shown) provided for the respective drives as the disk rotates and as the head moves.

The MPEG-2 decoder 206 (which will be simply referred to herein as a “decoder 206”) analyzes the partial TS supplied to get MPEG-2 compression-encoded data. Then, the decoder 206 expands the compression-encoded data, converts it into decompressed data and then passes it to the graphic control section 207. The decoder 206 can convert not only the MPEG-2 compression encoded data but also still picture data compliant with the JPEG standard into decompressed data. The graphic control section 207 is connected to the internal computer memory 208 and realizes an on-screen display (OSD) function. For example, the graphic control section 207 combines any of various menu pictures with the video and outputs the resultant synthetic image to the D/A converter 209. In response, the D/A converter 209 converts the input OSD synthetic image and audio data into analog data and outputs them to the TV 106, for example.

The CPU bus 213 is a path for transferring signals in the recorder 100 and is connected to the respective functional blocks as shown in FIG. 5. In addition, the respective components of the system control section 250 to be described later are also connected to the CPU bus 213.

The network control section 214 is an interface for connecting the recorder 100 to the network 101 such as the Internet and is a terminal and a controller that are compliant with the Ethernet™ standard, for example. The network control section 214 exchanges data over the network 101. The data may be timetable data about broadcast programs and updated data of a software program for controlling the operation of the recorder 100.

The instruction receiving section 215 is either an operating button arranged on the body of the recorder 100 or a photodetector section for receiving an infrared ray from a remote controller. The instruction receiving section 215 receives a user's instruction to start or stop a recording operation or to start or stop playing back a recorded program. Furthermore, the instruction receiving section 215 receives a user's instruction to copy a still picture from the memory card 112 loaded to the BD 205a and/or the HDD 205b.

The interface (I/F) section 216 controls the connector for use to allow the recorder 100 to communicate with other devices and also controls the communications themselves. The I/F section 216 includes a terminal compliant with the USB 2.0 standard, a terminal compliant with the IEEE 1394 standard, and a controller for enabling data communications according to any of these various standards and can exchange data according to a method that complies with any of these standards. For example, the recorder 100 may be connected to the PC 108 or a camcorder (not shown) by way of the USB 2.0 terminal and to a digital high-definition TV tuner or the camcorder (not shown) by way of the IEEE 1394 terminal, respectively.

The memory card control section 217 includes a slot for loading the memory card 112 into the recorder 100 and a controller for controlling data communications between the recorder 100 and the memory card 112. The memory card control section 217 receives the moving picture data, the still picture data and their management information over the CPU bus 213 and writes them on the memory card 112 or 113 loaded. Also, the memory card control section 217 reads out a still picture data file, a moving picture data file or any other file from the memory card 112 or 113 loaded and transmits it over the CPU bus 213.

The system control section 250 controls the overall processing of the recorder 100 including the signal flows there and includes a program ROM 210, a CPU 211 and a RAM 212, all of which are connected to the CPU bus 213. A software program for controlling the recorder 100 is stored in the program ROM 210.

The CPU 211 is a central processing unit for controlling the overall operation of the recorder 100. By reading and executing a program, the CPU 211 generates a control signal to realize the processing defined by the program and outputs the control signal to the respective components over the CPU bus 213. Also, the CPU 211 generates the management information to be described later, including the management file 82, playlist file 83, and clip information file 84 shown in FIG. 24, and output the information to the TS processing section 204 and memory card control section 217 over the CPU bus.

The memory 212 has a work area for storing data that is needed for the CPU 211 to execute the program. For example, the CPU 211 reads out a program from the program ROM 210 and outputs it to the random access memory (RAM) 212 through the CPU bus 213 and executes the program. The computer program may be circulated on the market by being stored on a storage medium such as a CD-ROM or downloaded over telecommunications lines such as the Internet. As a result, a computer system that is set up using a PC and so on can also operate as a data processor having functions that are equivalent to those of the recorder 100 of this preferred embodiment.

FIG. 6 shows the detailed arrangement of functional blocks in the TS processing section 204. The TS processing section 204 includes a source packetizer 261, a clock counter 262, a PLL circuit 263, a buffer 264, and a source depacketizer 265.

The source packetizer 261 receives a partial TS and adds a predetermined header to the top of a TS packet included in the partial TS, thereby generating and outputting a source packet. The header includes an arrival time stamp (ATS) showing the time when the TS packet was received (i.e., the arrival time of that TS packet). The arrival time of the TS packet can be calculated based on a count value (count information) from a reference time that has been given to the source packetizer 261. The reason why the information about the arrival time of the TS packet is included will be described later with reference to FIG. 7.

The clock counter 262 and the PLL circuit 263 generate information that is needed for the source packetizer 261 to find the arrival time of the TS packet. First, the PLL circuit 263 extracts a PCR packet (i.e., PCR_TSP shown in FIG. 2) from the partial TS and gets a program clock reference (PCR) representing a reference time. The same value as the PCR value is set as the system time clock (STC) of the recorder 100, which is used as a reference time. The system clock of the system time clock STC has a frequency of 27 MHz. The PLL circuit 263 outputs the 27 MHz clock signal to the clock counter 262, which receives the clock signal and outputs it as count information to the source packetizer 261.

The buffer 264 includes a write buffer 264a and a read buffer 264b. The write buffer 264a sequentially stores the source packets received and outputs them to the BD 205a, for example, such that the packets are written there when the overall data size reaches a predetermined value (e.g., the full capacity of the buffer). The series of source packets to be output at this time (i.e., a data stream) will be referred to herein as a “clip AV stream”. On the other hand, the read buffer 264b temporarily buffers the clip AV stream that has been read out from the BD 205a, for example, and outputs it on a source packet basis.

The source depacketizer 265 receives the source packets, converts them into TS packets, and then outputs them as a partial TS. It should be noted that the source depacketizer 265 outputs the TS packets at time intervals corresponding to the original arrival time in accordance with the timing information provided by the clock counter 262 and the TS packet arrival time stamp ATS included in the source packet. As a result, the TS processing section 204 can output the TS packets at the same timing as the arrival of the TS packets during the recording operation. To find the reference time of the partial TS that has been read, the source depacketizer 265 sends the arrival time, which is specified in the first source packet, for example, as an initial value to the clock counter 262. As a result, the clock counter 262 can start counting at that initial value and the result of the subsequent counting can be received as timing information.

Hereinafter, it will be described with reference to FIG. 7 exactly what type of processing is carried out by the TS processing section 204. Portions (a) through (e) of FIG. 7 show a correlation between a transport stream and a clip AV stream. For the purpose of reference, portion (a) of FIG. 7 shows a full TS 70, in which TS packets, including the data of three programs X, Y and Z, may be arranged in series, for example. Portion (b) of FIG. 7 shows a partial TS 71 that has been generated by the digital tuner 201a from the full TS 70. The partial TS 71 is a stream formed by extracting some packets from the continuous full TS. Thus, in the partial TS 71, those packets are dispersed discretely on the time axis. However, the intervals between those packets have been adjusted by the sender of the full TS so as to satisfy the conditions to make the decoder decode appropriately. Those “conditions” are laid down by the MPEG standard such that the buffer memory of a TS system target decoder (T-STD), defined as an ideal model of an MPEG-2 TS, does not cause an overflow or underflow.

The partial TS 71 may include the TS packets about the program X, for example.

Portion (c) of FIG. 7 shows a clip AV stream 72, in which source packets are arranged continuously. Those source packets are identified by source packet numbers (SPN) #1, 2, 3 and so on.

Portion (d) of FIG. 7 shows the data structure of a source packet 73, which has a fixed data length of 192 bytes. More specifically, each source packet 73 is formed by adding a TP extra header 74 of 4 bytes to the top of a TS packet 75 of 188 bytes. The source packetizer 261 generates the source packet by adding the TP extra header 74 to the top of a TS packet in the partial TS.

Portion (e) of FIG. 7 shows the data structure of the TP extra header 74. The TP extra header 74 is made up of a copy permission indicator (CPI) 76 of 2 bits and an arrival time stamp (ATS) 77 of 30 bits. The copy permission indicator (CPI) 76 indicates, by its bit value, how many times (i.e., zero times (copy prohibited), only once or an unlimited number of times) part or all of the clip AV stream 72 may be copied. The arrival time stamp (ATS) 77 describes the time at a precision of 27 kHz.

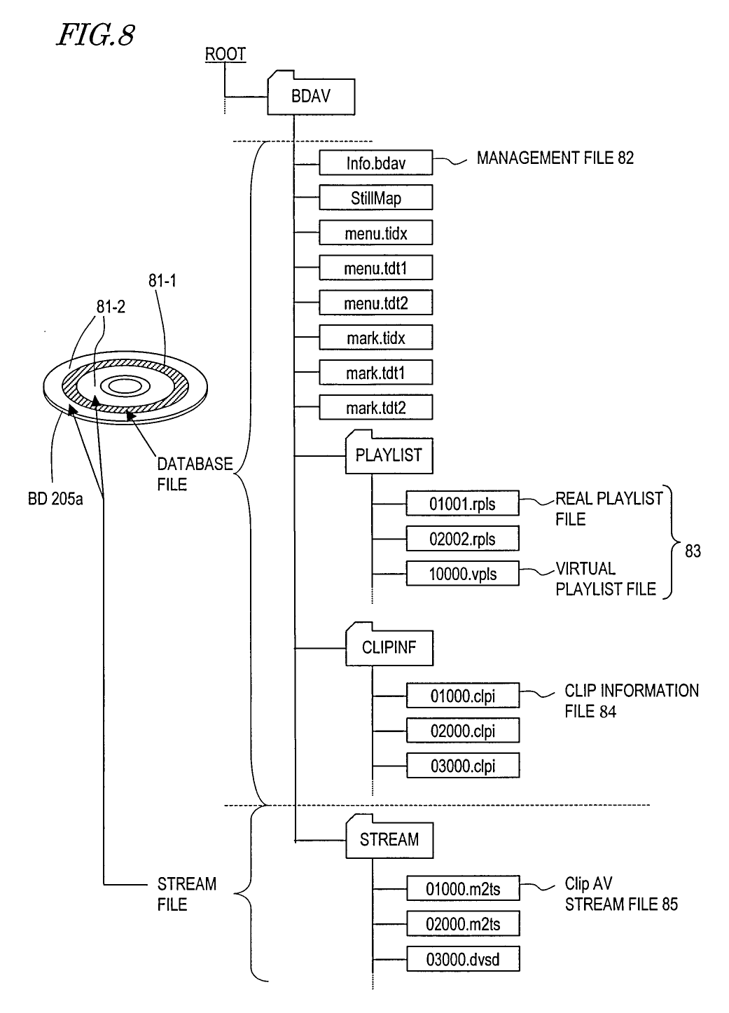

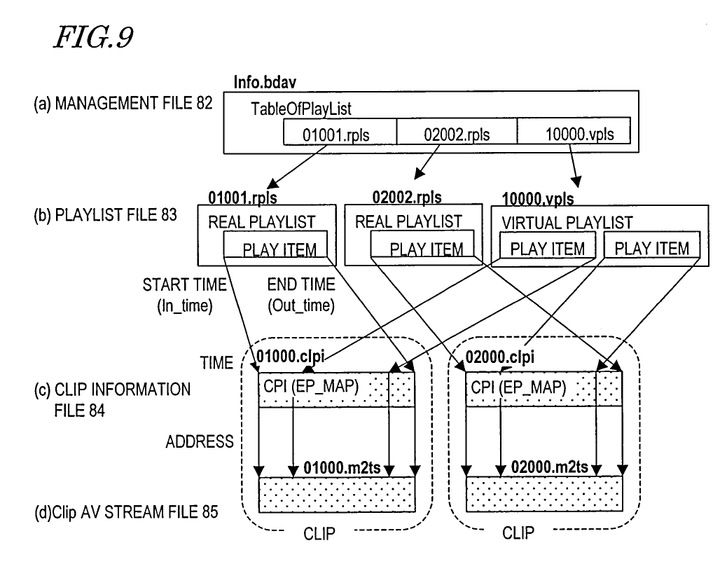

Next, it will be described with reference to FIG. 8 how the clip AV stream is recorded on the BD 205a. In this preferred embodiment, the clip AV stream may be written on other storage media such as the memory card 112 or 113, not just the BD 205a. In the memory card 112 or 113, a different file system (e.g., the FAT 32 file system according to this preferred embodiment) from that of the BD 205a is adopted. Thus, it will be described first how a clip AV stream is written on the BD 205a and then how the clip AV stream is written on a storage medium that adopts the FAT 32 file system.

It should be noted that the clip AV stream may be recorded on the HDD 205b. In that case, either the file system of the BD 205a or the FAT 32 file system may be adopted. However, as the HDD 205b is not usually removed from the recorder 100 and installed in another device, the data may be written there using a unique data structure as well.

FIG. 8 shows a storage area on the BD 205a and its directory/file structure. The BD 205a includes a gathered file area 81 and a real-time data area 82. The gathered file area 81 has a storage capacity of several hundreds of megabytes. In the gathered file area 81, stored are management information files (or database files) for managing the playback of the clip AV stream. As shown in FIG. 8, there are multiple types of database files including a management file (Info.bdav) 82, playlist files (01001.rpls and 10000.vpls) 83 and a clip information file (01000.clpi) 84. These database files are accessed rather frequently. That is why the gathered file area 81 is located at the center of the storage area of the BD 205a that can be accessed efficiently. Also, the database files are indispensable for playing back a moving picture stream such as the clip AV stream. Thus, an error contained there, if any, would cause a serious trouble. For that reason, the database files may be backed up in a BACKUP directory (not shown) within the same BDAV directory.

On the other hand, the real-time data area 81-2 has a storage capacity of 23 to 27 gigabytes on a single-sided single-layer Blu-ray disc. In the real-time data area 81-2, stored is a stream file representing the clip AV stream (e.g., a clip AV stream file (01000.m2ts) 85). Unlike the database files described above, a read error of a stream file, if any, would have only a local effect. But the stream file needs to be read continuously. That is why write processing is carried out so as to guarantee continuous reading rather than reducing the errors. Specifically, the clip AV stream file 85 is written on a continuous area (i.e., a continuous logic sector) with a minimum size of 12 megabytes. This minimum size of data to be written is called an “extent”. It should be noted that a DV stream could also be written on the real-time data area 81-2. In the following description, however, the clip AV stream is supposed to be written there.

Next, the correlation among the management file 82, the playlist file 83, the clip information file 84 and clip AV stream file 85 will be described with reference to portions (a) through (d) of FIG. 9, which shows a relationship between the management information and the stream data. The management information is shown in portions (a) through (c) of FIG. 9, while the stream data is shown in portion (d) of FIG. 9. Portion (a) of FIG. 9 shows a table of playlists described in the management file (Info.bdav) 82. That is to say, a table of playlist file names that signify the playlists on the BD 205a is stored in the management file 82. As used herein, the “playlist” refers to a piece of information that defines a playback path for a part or all of more than one clip AV stream.

Portion (b) of FIG. 9 shows playlists that are described in the playlist file 83 and that have extensions rpls and vpls. The playlists are classifiable into real playlists and virtual playlists. A real playlist may be generated by the recorder 100 when stream data is written for the first time, for example, and its playback path is specified as from the beginning through the end of a moving picture. Meanwhile, a virtual playlist is specified by the user with respect to the stream data written, and therefore, the user can specify any locations and ranges he or she likes.

Each range of a playlist is defined by respective play items in the playlist. Specifically, the play items describe a start time (In_time) corresponding to the presentation start time and an end time (Out_time) corresponding to the presentation end time. The start and end times are described as presentation time stamps (PTS) specifying the presentation time of a video frame played back and the output time of an audio frame reproduced. Just after a recording operation has been finished, a real playlist usually defines only one play item to specify the start and end times of a moving picture. Meanwhile, a virtual playlist may define any number of play items. Multiple play items may be provided for a single virtual playlist and may be described so as to specify mutually different moving picture streams.

Portion (c) of FIG. 9 shows a time/address conversion table (EP_map) 84 that is described in clip information files 84 with an extension clpi. The conversion table (EP_map) 84 shows a correspondence between the presentation time of a clip AV stream and an address at which the data to be presented at that time is stored. By reference to this conversion table 84, the address in the clip AV stream, at which the data to be presented at that time is stored, can be detected based on the start time (In_time) and end time (Out_time) specified by the play item. The principle of conversion using this conversion table 84 will be described more fully later with reference to FIGS. 13 through 15.

Portion (d) of FIG. 9 shows a moving picture stream that is stored in clip AV stream files 85 with an extension m2ts. In this portion (d) of FIG. 9, the files “01000.m2ts” and “02000.m2ts” are clip AV stream files.

As shown in portions (c) and (d) of FIG. 9, a single clip information file is provided for each single clip AV stream file on the BD 205a. Such a combination of a clip AV stream file and a clip information file will be referred to herein as a “clip”.

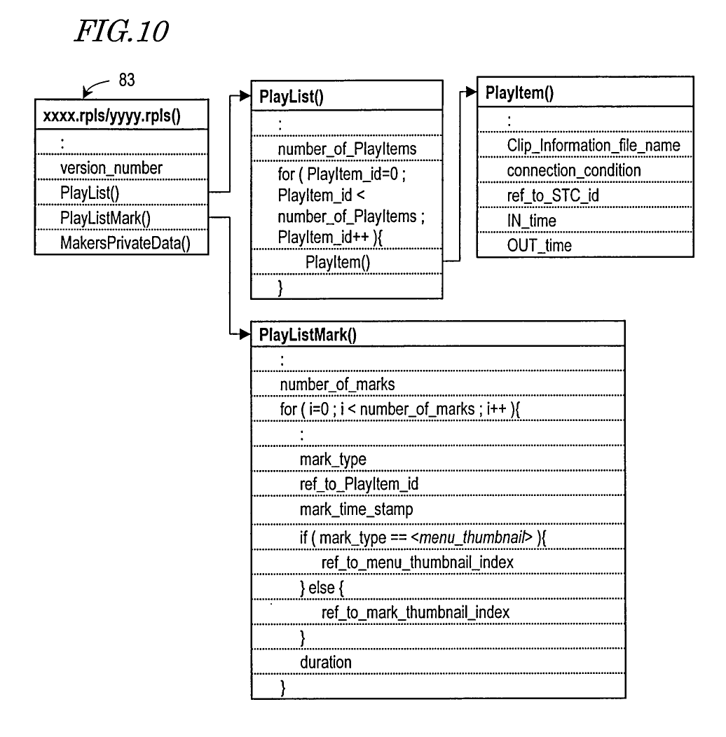

FIG. 10 shows information (entries) stored in the playlist file 83 and its data structure. In a file 83 with an extension “rpls” or an extension “vpls”, there is an entry shown as PlayList( ), which corresponds to the playlist described above. Play items (PlayItems) #1, 2, and so on are described as low-order entries of the playlist information (PlayList). In each of these play items, stored are the file name of a clip information file to be played back (Clip_Information_file_name), an identifier for identifying an STC (ref_to_STC_id), a start time (In_time), an end time (Out_time) and so on. The playlist file 83 may also include an entry shown as a “PlayListMark”, the function of which will be described later.

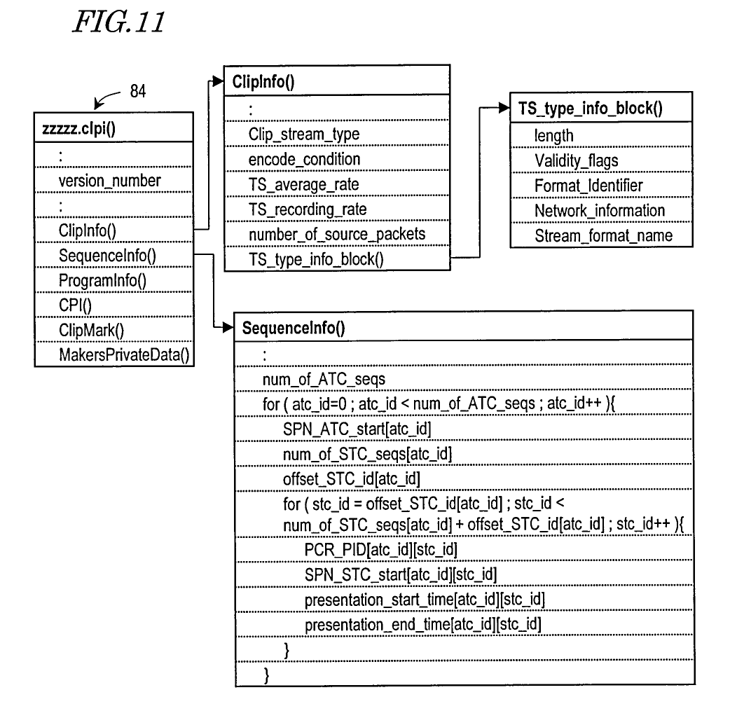

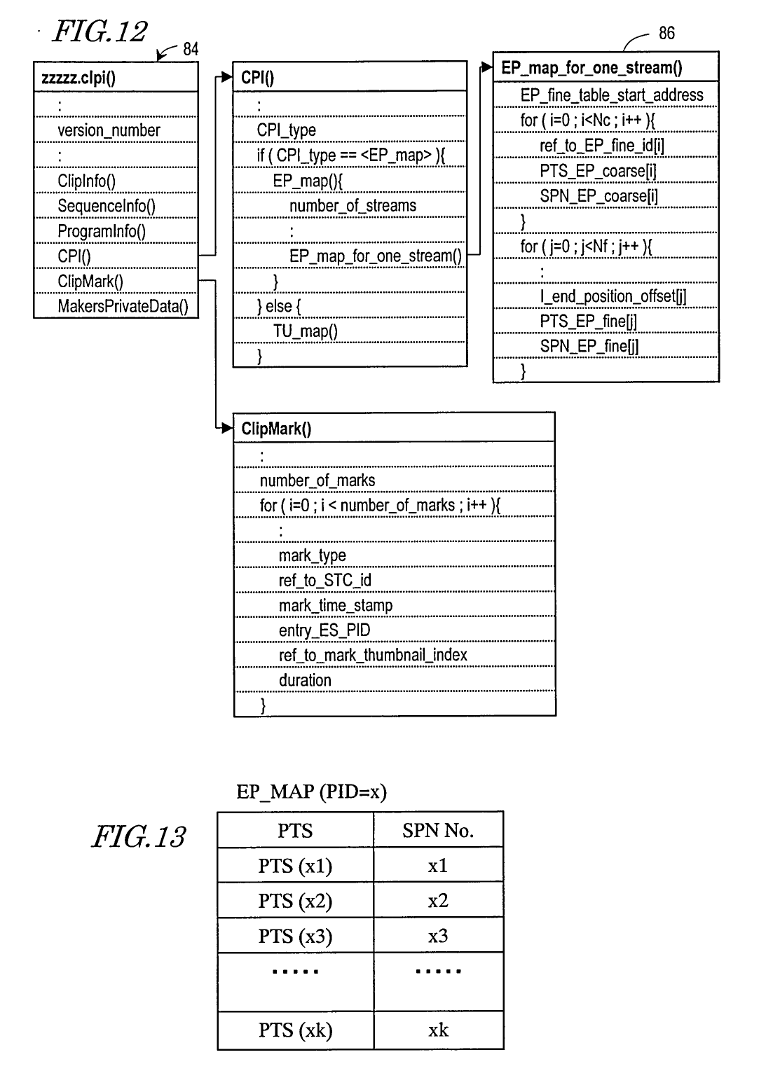

FIGS. 11 and 12 show the information (entries) stored in the clip information file 84 and the data structures of the entries of the clip information file. The clip information file 84 includes various entries. Among those entries, the detailed data structures of the clip-related information (ClipInfo) and sequence information (SequenceInfo) are shown in FIG. 11. The clip-related information (ClipInfo) also includes a number of entries. FIG. 11 shows the detailed data structure of one entry (TS_type_info_block) included in the clip-related information.

Also, as can be seen from FIG. 12, the time/address conversion table (EP_map) is provided as an entry in the characteristic point information (CPI). This table is a set of time-address conversion tables (EP_map_for_one_stream), each of which is provided for associated one of the more than one clip AV stream. The table 86 shows the data structure of the time-address conversion table (EP_map_for_one_stream) for each clip AV stream. Other entries (ClipMark and so on) will be described later. The conversion table (EP_map) is provided for each program recorded, i.e., for the PID of every video TS packet recorded.

As shown in the CPI table of FIG. 12, TU_map may be provided instead of the EP_map. TU_map is a table showing the correspondence between the arrival time stamps (ATS) of the packets and the source packet numbers. The packet arrival time entries may be provided at an interval of one second, for example. And the number of the source packet generated from the TS packet that has been received for the first time immediately after that time is associated with that time.

Next, the data structure of a time/address conversion table (EP_map) and the principle of a time/address conversion to be done using the conversion table 84 will be described with reference to FIGS. 13 through 15. FIG. 13 shows the data structure of a time/address conversion table. On this conversion table, a time stamp PTS representing a time is associated with a source packet number SPN representing an address. As far as video is concerned, this time stamp PTS is that of each I-picture arranged at the top of a GOP compliant with an MPEG standard. Also, the source packet number SPN is the number of a source packet in which the top data of an I-picture played back at the time corresponding to the PTS is stored. Each source packet has a data size of 192 bytes. Therefore, if the source packet number is known, the number of bytes as counted from the top of a clip AV stream can be figured out and that data can be accessed easily and just as intended. On this conversion table, the actual values of the source packet numbers X1, X2, and so on are not always consecutive integers but may also be integers with an increment of two or more.

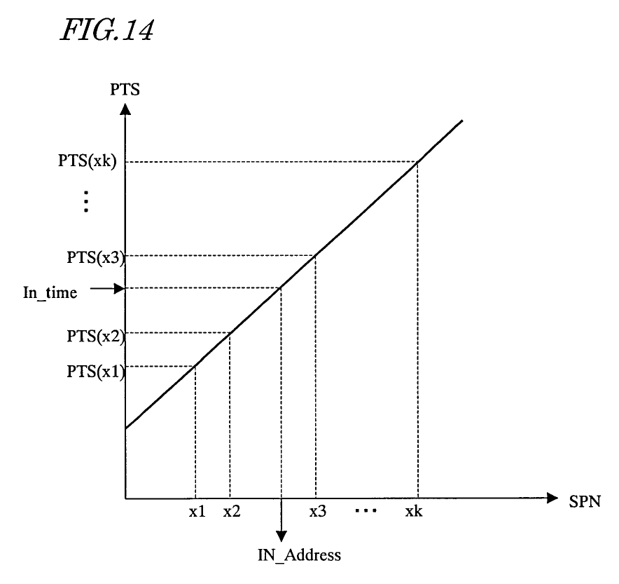

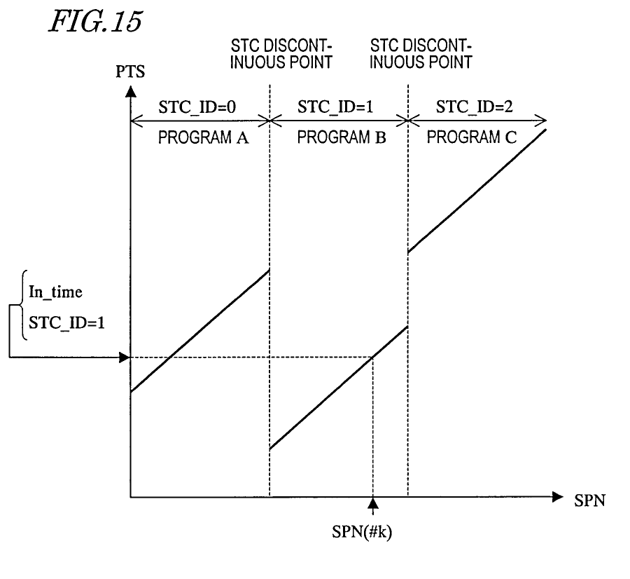

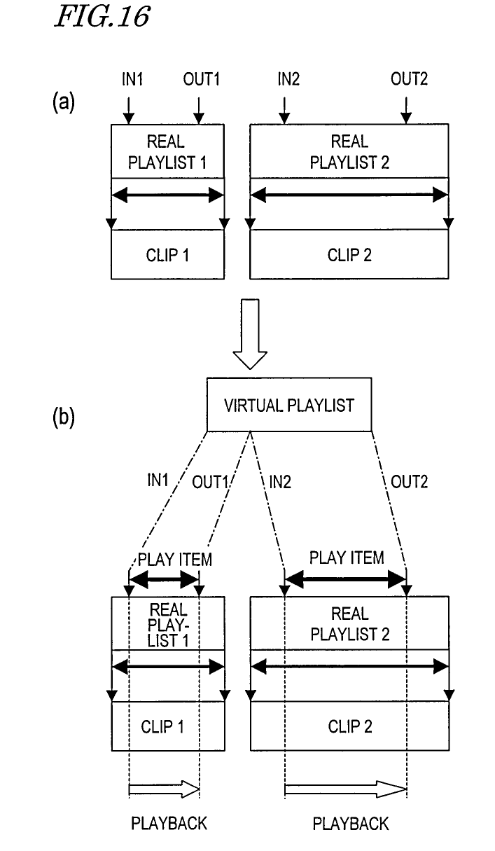

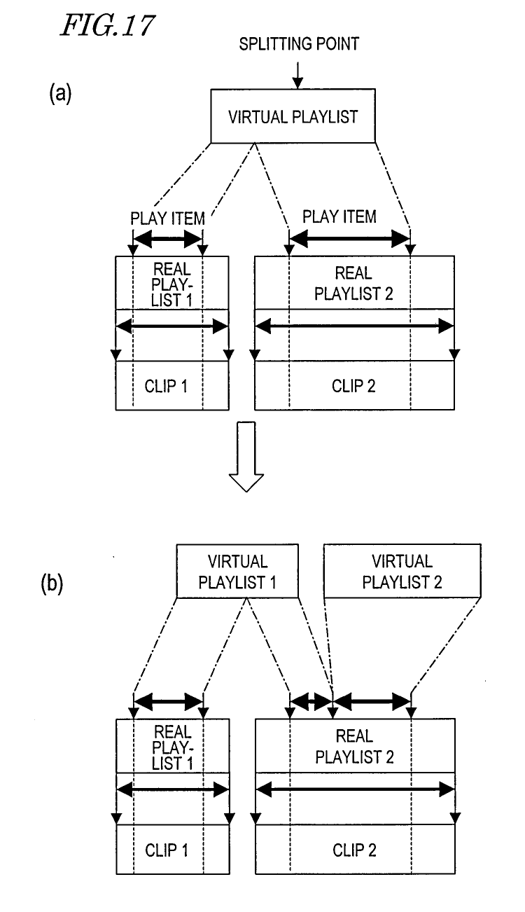

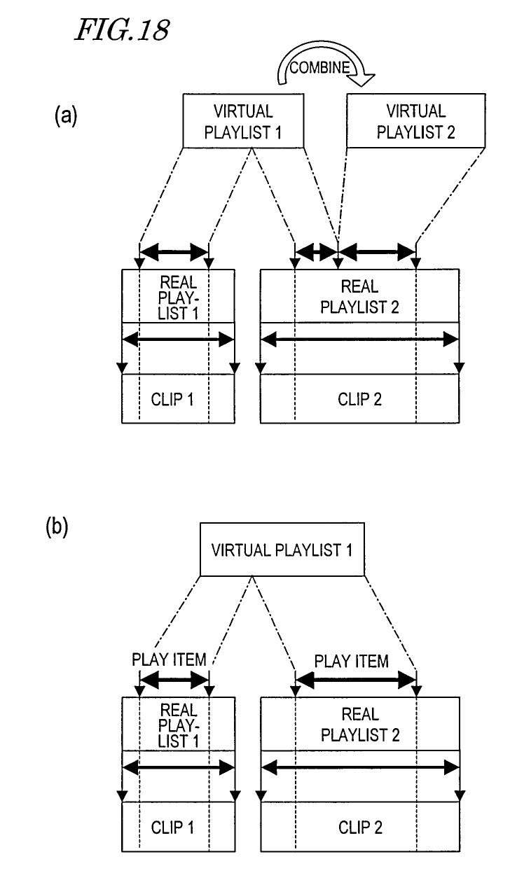

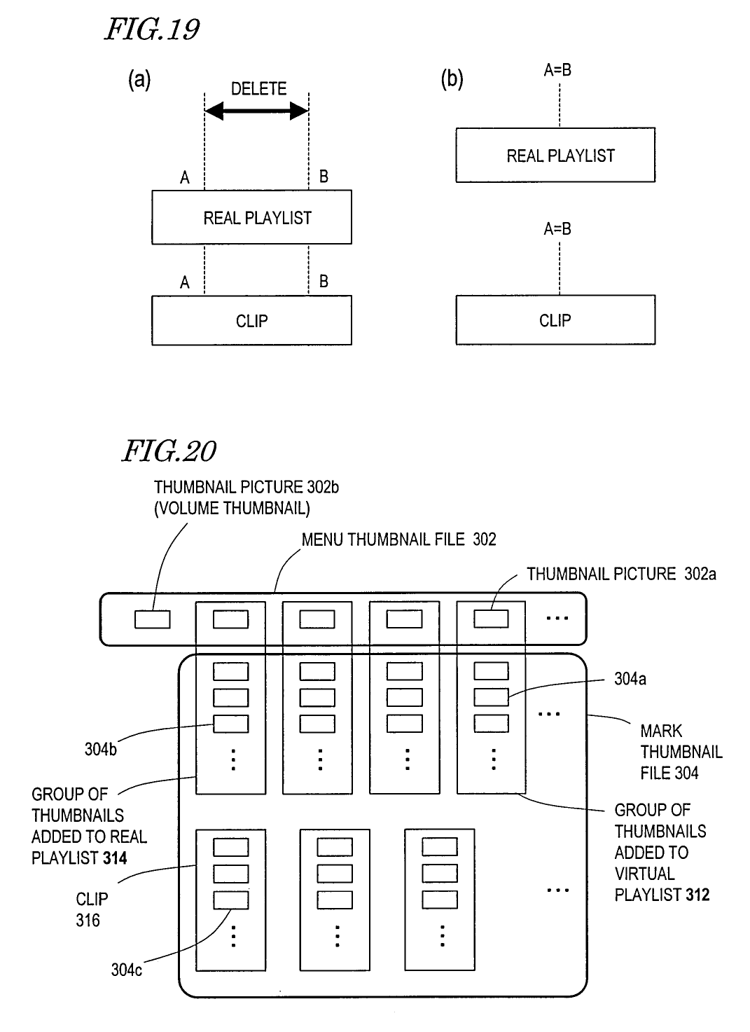

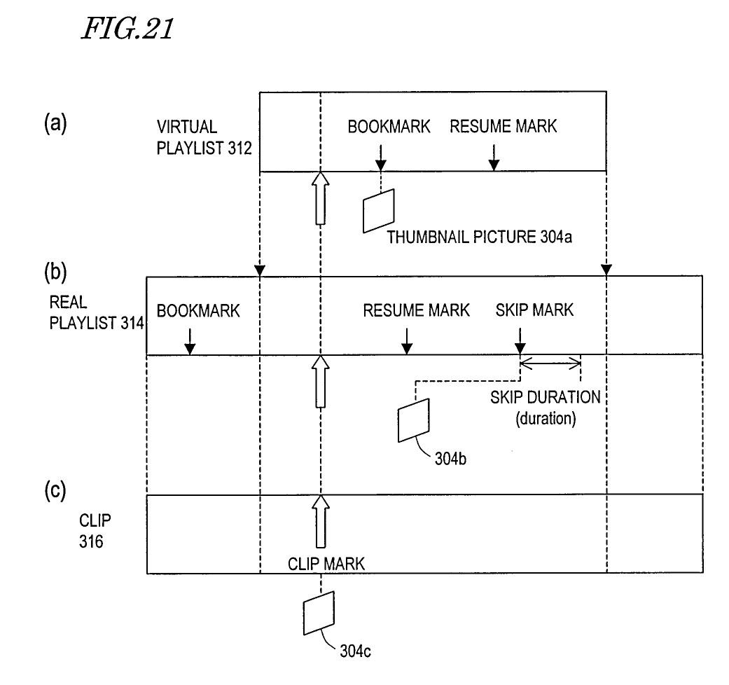

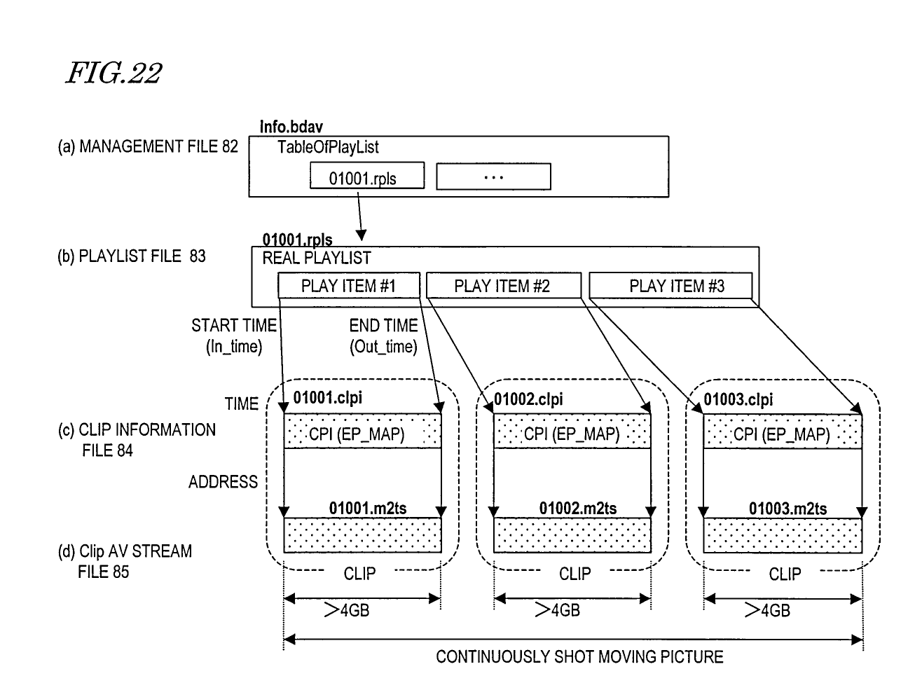

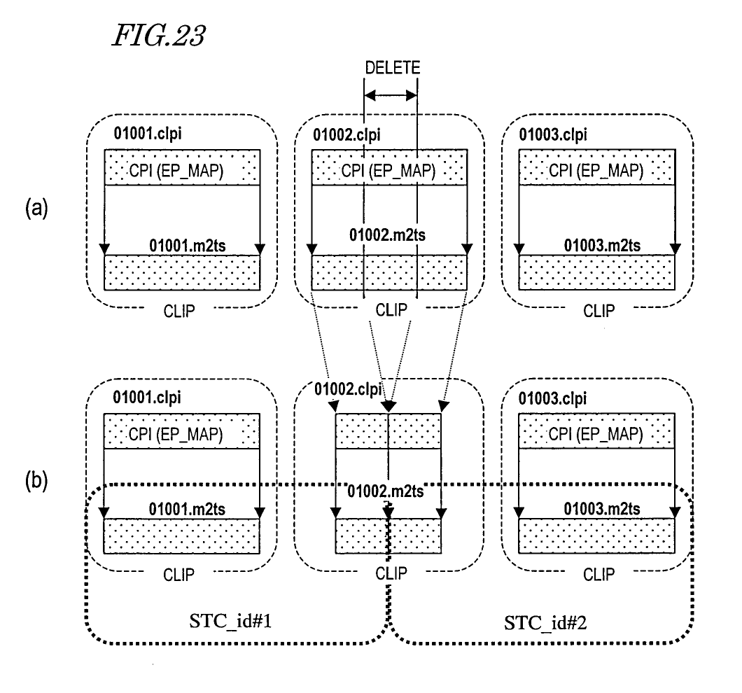

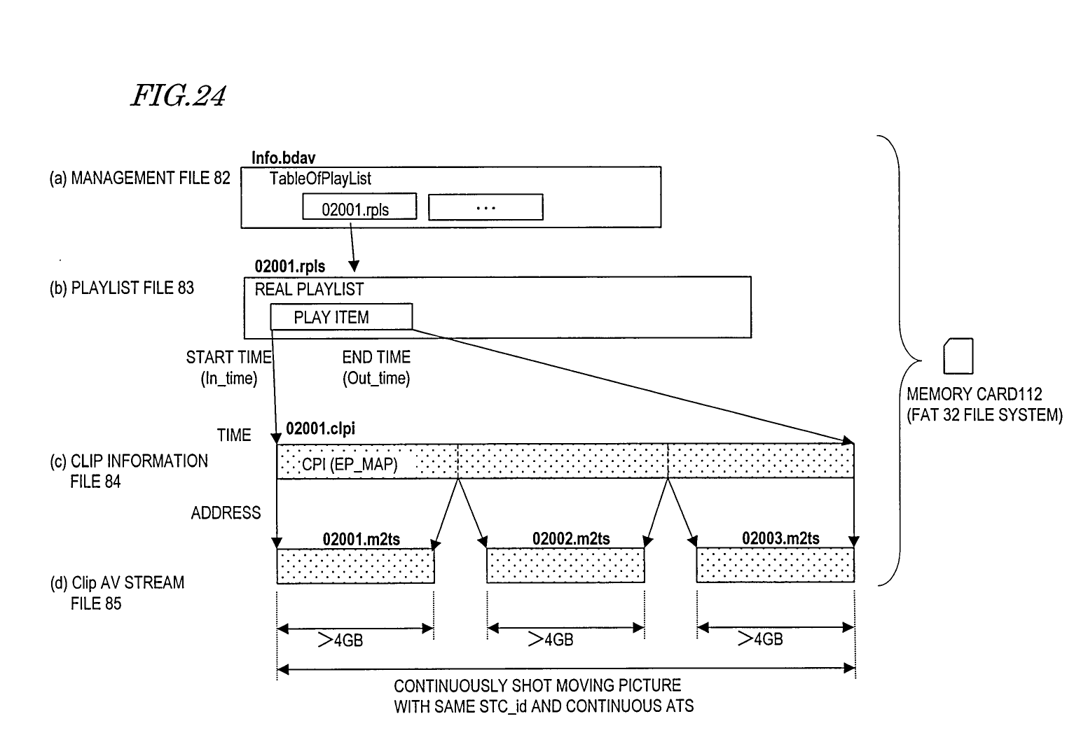

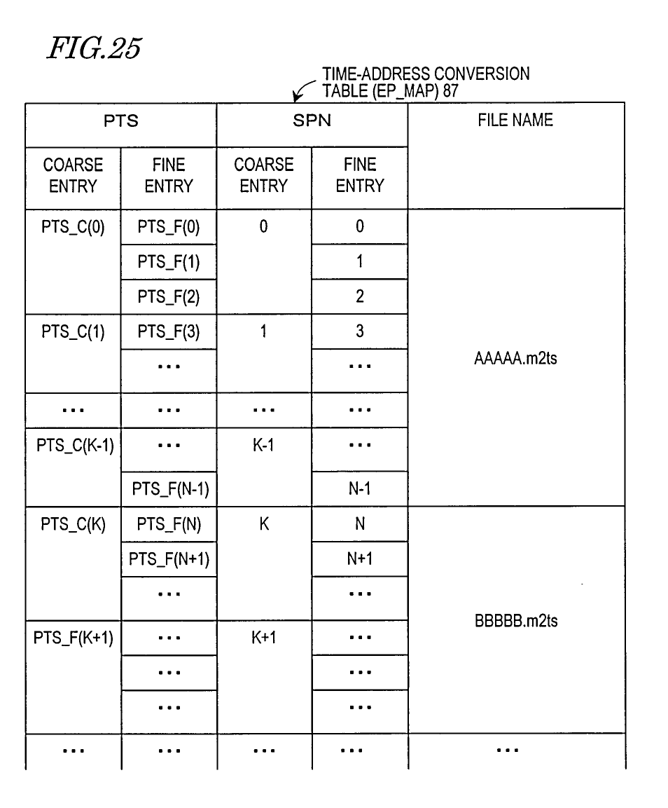

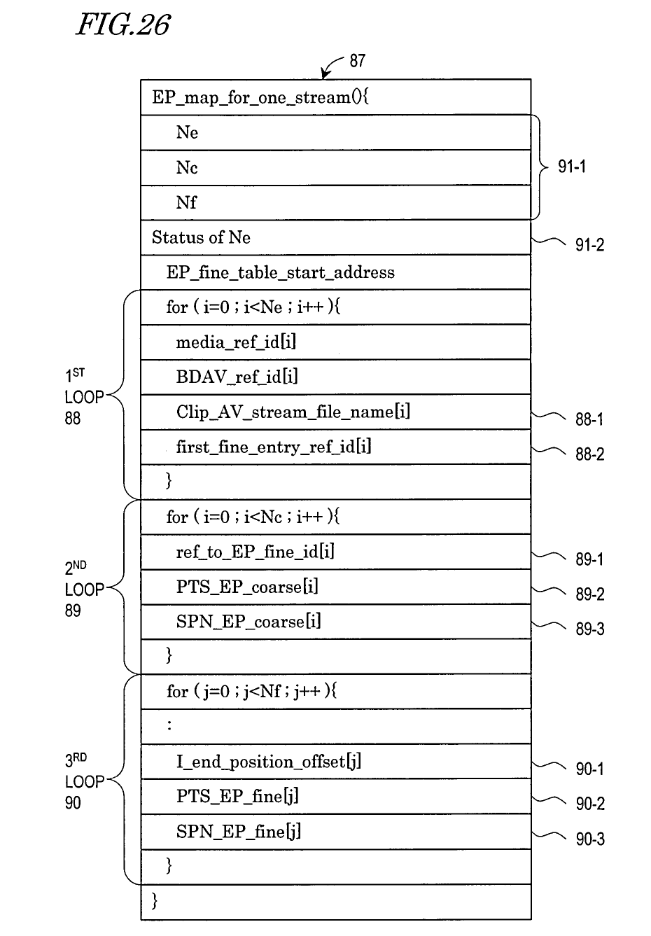

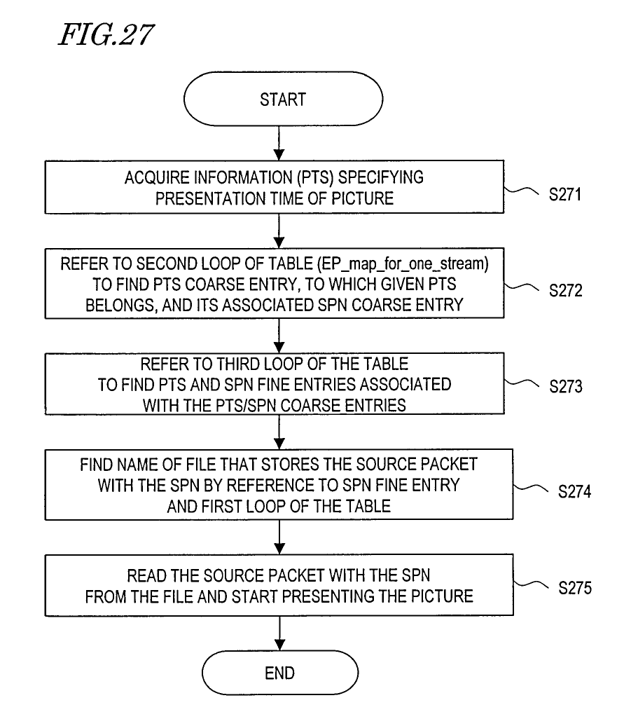

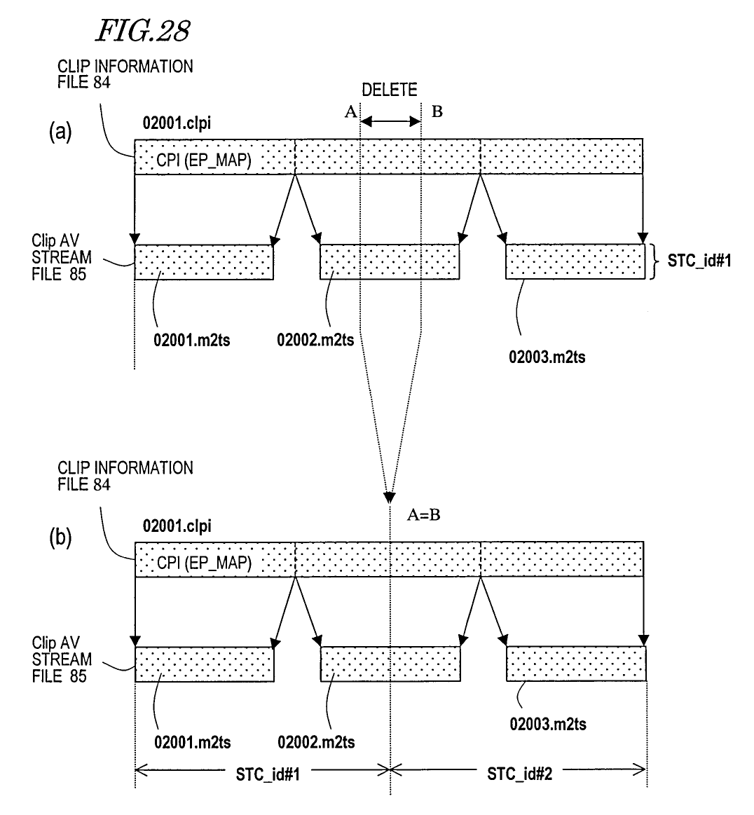

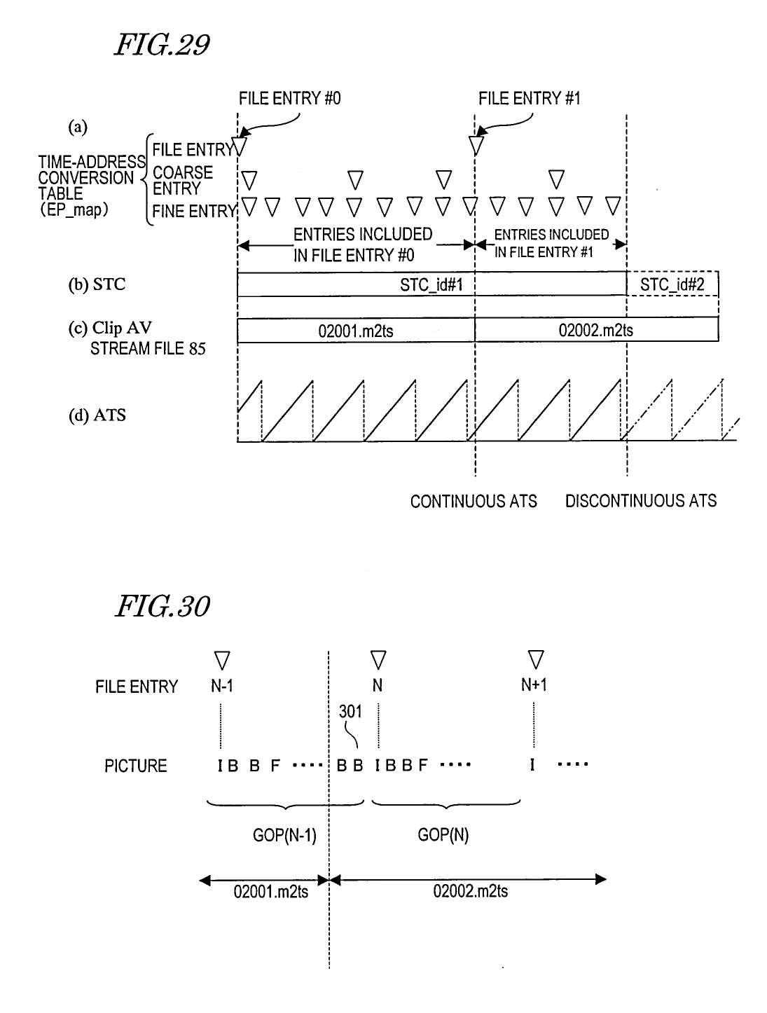

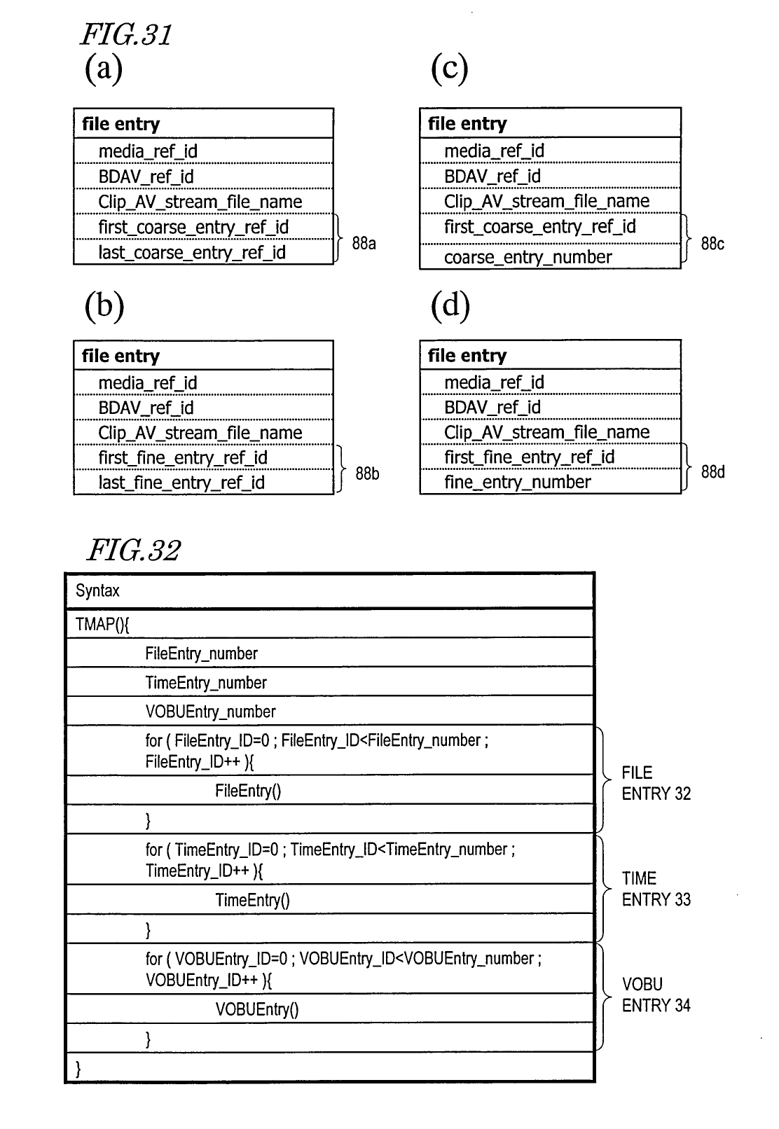

FIG. 14 shows a first exemplary time/address correlation. As described above, only the PTS value of each I-picture arranged at the top of a GOP is described on the time/address conversion table. That is why if another PTS value, different from the PTS value, is specified as either the start time (In_time) and/or the end time (Out_time), then the address (or source packet number) associated with that time cannot be obtained directly. According to the MPEG-2 Video compression coding method, however, compression processing is carried out using the difference between pictures. Therefore, unless the I-picture at the top of a GOP is decoded first, the pictures that follow cannot be decoded, either. That is why as long as the entry of an I-picture is described, no problem should occur in actual playback. And the playback of further picture units may be controlled by starting decoding from the I-picture specified on the time/address conversion table (EP_map) and subjecting only expected pictures to presentation processing while analyzing and decoding the pictures that follow.

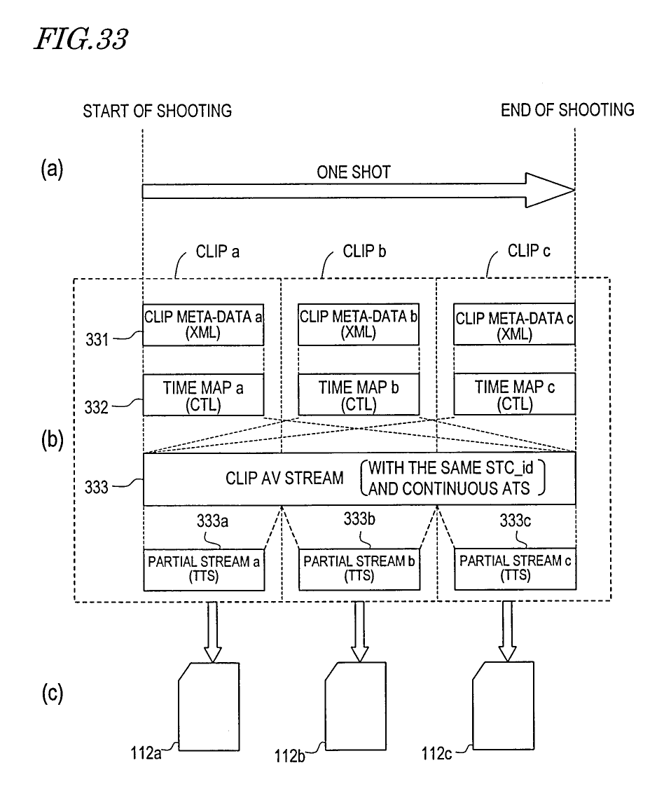

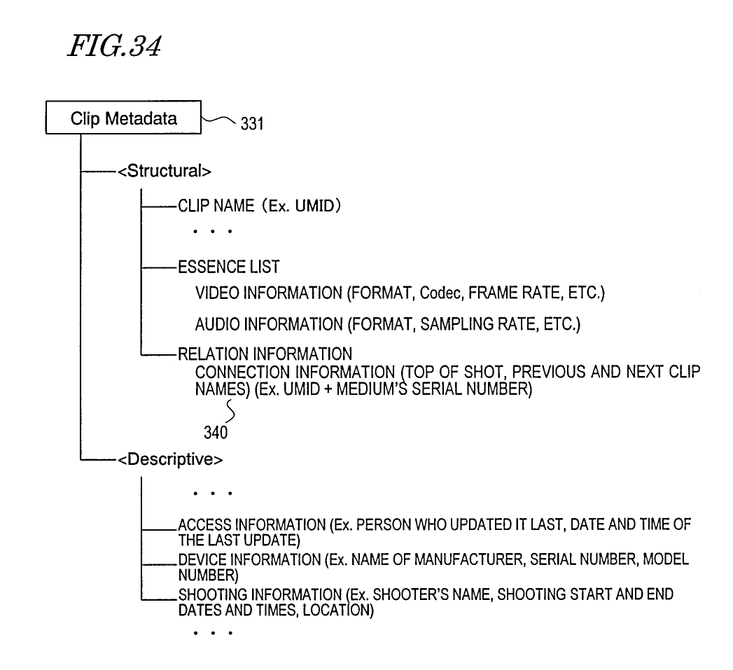

FIG. 15 shows a second exemplary time/address correlation. The difference from the example shown in FIG. 14 will be pointed out. The target of recording does not have to be a single broadcast program but may also be a number of continuous programs. In that case, although the PTS and source packet number may be defined uniquely for each program (within the partial TS), those values are not adjusted between the programs and may sometimes overlap with each other between multiple programs. That is why even in that case, the time/address conversion needs to be carried out just as intended using the time/address conversion table (EP_map). Thus, a piece of information STC_ID to identify a particular presentation point is defined and used, along with the time information, to find the source packet number.

First, the first recorded program is given STC_ID=0. As already described with reference to FIG. 6, each partial TS is processed by reference to its own system time clock STC. Thus, the system time clocks STC are discontinuous at the switching point of programs. FIG. 15 shows an example in which when Programs A, B and C are recorded, there are STC discontinuous points between Programs A and B and between Programs B and C. Different STC_IDs are set for respective timings. In FIG. 15, the first program A is given STC_ID=0, the next program B is given STC_ID=1, and the last program is given STC_ID=2. Besides, by defining the longest playback duration of a single STC_ID stream, it is guaranteed that the same PTS never exists even within the same STC_ID. Since the MPEG PTS has a length of 33 bits at a precision of 90 kHz, the presentation time can be shown properly by giving a unique PTS unless the duration is longer than about 26.5 hours.

By assigning STC_ID as described above, the proper source packet number can be obtained just as originally specified by reference to the time information (In_time and Out_time) and STC_ID. It can be seen that PlayItem( ) shown in FIG. 10 includes not only information about the start time (IN_time) and end time (OUT_time) but also an entry (ref_to_STC_id) to specify STC_ID.

It should be noted that if the device itself generates a clip AV stream by encoding a video signal as in the camcorder 110, the STCs do not have to be discontinuous within a series of recording intervals from the start through the end of one video recording session. In that case, the operation of the device may be controlled such that the STCs do not become discontinuous within that series of recording intervals. The same statement applies when the recorder 100 receives a video signal and encodes it using the ADC 202 and the encoder 203.

Next, it will be described with reference to FIGS. 16 through 19 how to edit a clip AV stream using a virtual playlist. Portion (a) of FIG. 16 shows real playlists Nos. 1 and 2 with their associated Clips Nos. 1 and 2. Suppose a virtual playlist for playing back respective portions of Clips Nos. 1 and 2 continuously should be made. Portion (b) of FIG. 16 shows a virtual playlist for playing back a first interval from IN1 through OUT1 and a second interval from IN2 through OUT2 continuously. The first and second intervals are specified by mutually different play items in the virtual playlist. The virtual playlist can apparently combine respective playback intervals of two different clips with each other without directly processing real playlists Nos. 1 and 2 and Clips Nos. 1 and 2.

However, since the MPEG-2 Video compression coding method requires that compression be done based on the difference between pictures as described above, the picture cannot be usually decoded, and no video can be presented for a while, just after the picture has been retrieved at IN2. This is because the data of its preceding picture that is needed to decode that picture has not been gotten yet.

To realize seamless playback of video only, the video needs to be re-encoded at connection points by making destructive editing on the original stream. In that case, the connection information (connection_condition) of the play item is set to “4”. However, the destructive editing leaves no original video. Thus, a clip called “bridge clip” may be newly provided by assembling streams around a connection point together and re-encoding them to realize seamless connection without editing the original stream as in the destructive editing. During the playback, the playback controls are switched to the bridge clip just before the connection point and the second interval is played back after the bridge clip has been played back. As a result, the scenes can be changed seamlessly and smoothly. It should be noted that the connection information using this bridge clip is set to “3”.

Portion (a) of FIG. 17 shows the location of a splitting point for splitting the virtual playlist shown in portion (b) of FIG. 16. Portion (b) of FIG. 17 shows virtual playlists Nos. 1 and 2 that have been split. Virtual playlist No. 1 defines continuous playback of the entire interval of real playlist No. 1 and a partial interval of real playlist No. 2. On the other hand, virtual playlist No. 2 defines the playback of the remaining interval of real playlist No. 2.

Alternatively, a type of processing opposite to that of the processing shown in portions (a) and (b) of FIG. 17, i.e., combining a plurality of virtual playlists together, may also be carried out. Portion (a) of FIG. 18 shows Virtual playlists Nos. 1 and 2 to be combined together. Portion (b) of FIG. 18 shows the combined virtual playlist.

In both the example shown in portions (a) and (b) of FIG. 17 and the example shown in portions (a) and (b) of FIG. 18, by using the virtual playlist, the clips can be apparently slit or combined without directly processing real playlists Nos. 1 and 2 or Clips Nos. 1 and 2.

On the other hand, in partially deleting a real playlist, a clip and the real playlist need to be processed directly. FIG. 19(a) shows a real playlist and a clip, from which the interval A-B should be deleted, while FIG. 19(b) shows a real playlist and a clip, from which the interval A-B has been deleted and in which the points A and B have been combined together. The reason why the clip and the real playlist are directly processed only when the real playlist is deleted either partially or fully is that only the real playlist has direct causality with the video and audio data. That is to say, at the user interface on the recorder, only the real playlist (which has the same significance as the clip for the user) and the virtual playlist (mere playback path information) are supposed to be presented to the user without making him or her sense the clip.

Next, it will be described with reference to FIG. 20 how to manage thumbnail pictures. FIG. 20 shows a correlation between thumbnail pictures to be managed on the BD 205a and a management file. The thumbnail picture is a reduced size picture representing a scene of a moving picture or a still picture and is provided to make the contents of the moving picture and still pictures easily recognizable.

The thumbnail picture related data is stored in a plurality of files. In FIG. 20, shown are a menu thumbnail file 302 and a mark thumbnail file 304 for managing thumbnail pictures. The menu thumbnail file 302 stores index information about the thumbnails of the BD 205a or the playlist. This index information includes the management numbers (menu_thumbnail_index) of thumbnail pictures 302a, 302b, etc. to be managed on the menu thumbnail file 302. The thumbnail picture 302a shows the typical content of the virtual playlist 312. The thumbnail picture 302b is called a “volume thumbnail” and shows the typical content of the overall BDAV directory. In FIG. 8, a “menu.tidx” file corresponding to the menu thumbnail file 302 and “menu.tdt (n)” (where n=1, 2, . . . ) representing the substantive data of the respective thumbnail pictures are shown.

On the other hand, the mark thumbnail file 304 stores index information about “mark” thumbnails that are added to a desired video location and that function as a bookmark. This index information also includes the management numbers (mark_thumbnail_index) of thumbnail pictures 304a, 304b, 304c, etc. to be managed on the mark thumbnail file 304. The thumbnail picture 304a is a reduced size picture showing a location in the virtual playlist 312 to which a mark has been added. The thumbnail picture 304b is a reduced size picture showing a location in the real playlist 314 to which a mark has been added. And the thumbnail picture 304c is a reduced size picture showing a location in the clip 316 to which a clip mark has been added. In FIG. 8, a “mark.tidx” file corresponding to the mark thumbnail file 304 and “mark.tdt (n)” (where n=1, 2, . . . ) representing the substantive data of the respective thumbnail pictures are shown. The data of these thumbnail pictures has been compressed and encoded compliant with the JPEG standard.

By using the menu thumbnail file 302 and the mark thumbnail file 304 described above, all thumbnail pictures may be presented as a list or only the thumbnail pictures of particular marks may be presented selectively. As a result, the user can easily check out the outline of the moving picture being managed on the BD 205a, that of various playlists or that of a plurality of scenes of a particular playlist.

Portions (a) through (c) of FIG. 21 respectively show a virtual playlist 312, a real playlist 314 and a clip 316, to each of which a mark has been added. On the BD 205a, the user can put several types of marks. Examples of those marks include a “bookmark” specifying the playback start point of a desired moving picture (content), a “skip mark” specifying the point (or interval) not to play back but to skip, a “resume mark” specifying the location where viewing was stopped last time, and a “chapter mark” specifying the top of a chapter.

A bookmark and a resume mark have been added to the virtual playlist 312 shown in portion (a) of FIG. 21. These marks are described on the “PlayListMark” entry of a playlist file (with an extension vpls). In FIG. 10, PlayListMark( ) corresponding to the PlayListMark entry is shown. In PlayListMark( ), “mark_type” is a piece of information showing the type of a mark such as a bookmark or a resume mark. On the other hand, “mark_time_stamp” is a piece of information specifying the time stamp (PTS) of a picture to which the mark has been added. Each mark may be associated with a thumbnail picture. The thumbnail picture 304a shown in portion (a) of FIG. 21 is a reduced size picture of a scene for which the bookmark has been set. The thumbnail picture 304a provided for the virtual playlist 312 is managed on the mark thumbnail file 304.

Next, a bookmark, a resume mark and a skip mark have been added to the real playlist 314 shown in portion (b) of FIG. 21. As for the skip mark, a thumbnail picture 304b can also be provided for the skip start point, and the duration of skip may also be defined.

A clip mark has been added to the clip 316 shown in portion (c) of FIG. 21. The clip mark is added by the recorder 100 when a clip AV stream is generated. The user can do nothing about the generation of the clip mark or the deletion of the clip mark generated. The clip mark is directly added to the clip, and therefore, can function effectively even while playback is carried out based on the playlists 312 and 314. A thumbnail picture 304c may also be provided for the clip mark.

The ID of the maker (maker_ID) of the recorder (such as the recorder 100) and its own information (makers_private_data) may be added to each of those marks. Then, each individual maker can expand the functions of the apparatus by using those marks.

In the foregoing description, a moving picture stream is supposed to be recorded, edited and played using a file system that enables the user to handle video/audio data files very easily (e.g., the UDF). Next, it will be described how to record, edit and play a moving picture stream with the FAT 32 system that is adopted extensively by PCs today.

The FAT 32 file system is not set up to handle mainly video/audio data files. That is why it is not appropriate to use the data structure of the file system described above as it is for various types of files on the FAT 32 file system. This is because files with sizes exceeding 4 GB cannot be recorded according to the regulations of the FAT 32 file system. If a program has been recorded, or video has been shot, for a long time, there are a lot of chances that the moving picture stream has a data size of more than 4 GB. Hereinafter, it will be described with reference to FIGS. 22 and 23 exactly what problem would arise if the data structure described above were applied as it is to the FAT 32 file system.

Portions (a) through (d) of FIG. 22 show a first example in which a clip AV stream 85 and its associated management information files 82 to 84 are provided in the FAT 32 file system. Specifically, portion (d) of FIG. 22 shows that the moving picture data that has been captured or recorded continuously has been split into, and stored as, multiple files. As the management file 82 shown in portion (a) of FIG. 22 is the same as that shown in portion (a) of FIG. 9, the description thereof will be omitted herein.

As shown in portions (c) and (d) of FIG. 22, according to the FAT 32 file system, a moving picture that has been captured or recorded continuously may be split into, and stored as, a number of clips. More specifically, the clip AV stream file 85 shown in portion (d) of FIG. 22 has been generated one to one for the clip information file 84 shown in portion (c) of FIG. 22 and the pair of these files is defined as a clip. The FAT 32 file system cannot handle files with sizes of 4 GB or more. That is why if the size of the continuously captured or recorded moving picture data becomes huge, a plurality of clip AV stream files, each having a size of less than 4 GB, may be generated. Then, a clip information file 84 is generated every time a clip AV stream file is generated. As a result, a number of clips are generated. To play back video over these clips, playback route information (playlist) needs to be provided to define how those clips should be connected together and a single playback sequence needs to be set. The playlist file 83 (01001.rpls) shown in portion (b) of FIG. 22 shows an example in which a number of clips are connected together as a single playback sequence. It should be noted that if the UDF shown in FIG. 9 is used, a continuously captured or recorded moving picture can be stored as a single clip.

Next, referring to FIG. 23, clips before and after editing are shown in portions (a) and (b) of FIG. 23. Specifically, portion (a) of FIG. 23 shows a clip editing range for the playlist generated in FIG. 22. In the example shown in portion (a) of FIG. 23, editing is supposed to be made by deleting an intermediate portion of the stream file 01002.m2ts. In this case, information is also deleted from its corresponding range of the clip information file (01002.clpi). Portion (b) of FIG. 23 shows the resultant edited clips (i.e., 01002.clpi file and 01002.m2ts file).

In the unedited state shown in portion (a) of FIG. 23, the continuously recorded moving picture stream has a single STC_id (i.e., STC_id=1). At this point in time, there is a single STC sequence over the multiple clip AV stream files.

In the edited 01002.m2ts file, however, there are two STC sequences as represented by STC_id #1 and STC_id #2 in portion (b) of FIG. 23. That is to say, there are multiple STC sequences in a single moving picture file. It should be noted that in the clip AV stream files 01001.m2ts and 01003.m2ts, a single STC sequence is still present over a plurality of clip AV stream files. Also, according to the contents of editing, there can be a single STC sequence in a single moving picture stream.

It can be easily seen that if such editing processing (i.e., partial deletion processing) is performed repeatedly, the relation between a file that stores a single moving picture stream and an STC sequence stored in the file will get further complicated.

Also, when a moving picture stream is recorded on a relatively small-sized storage medium with small storage capacity such as the semiconductor memory 112, the moving picture stream (or a single playlist) could be recorded on multiple different semiconductor memories because the recorder can have a plurality of memory card slots. In that case, the correlation between the storage media, moving picture stream files and STC sequence could get further complicated. As a result, the processing could also get complicated and delayed.

In view of these considerations, according to this preferred embodiment, a new data structure such as that shown in FIGS. 24 to 26 is defined to realize flexible data management. More specifically, instead of associating a single clip AV stream file with a single management information file (or clip information file), single or multiple clip AV stream files are associated with a single management information file (clip information file). If a plurality of streams are managed using only one management information file, then the relation between these files and the sequence can be defined just by reference to the time map (EP_map) as will be described later. As a result, the video to play can be specified by using only PTS and STC sequence.

This new data structure can be established by any of the recorder 100, the PC 108 and the camcorder 110. In the following description, the recorder 100 shown in FIG. 5 is supposed to establish this new data structure.

The encoder 203 and/or the CPU 211 of the recorder 100 can establish the data structure shown in FIGS. 24 to 26 both in recording video using analog signals and in recording video using digital signals. That is why an example in which video is recorded with analog signals will be described. The storage medium is supposed to be a memory card 112 that adopts the FAT 32 file system.

In this example, the encoder 203 performs the processing steps shown in portions (d), (c), (b) and (a) of FIG. 4 in this order, thereby generating a transport stream. The encoder 203 also generates PTS and other additional data for each picture and stores them in the PES header 41a-1 shown in portion (b) of FIG. 4. Then, the TS processing section 204 generates a clip AV stream based on the transport stream thus generated.

Meanwhile, the CPU 211 generates management information. The encoder 203 and the CPU 211 transmit the clip AV stream and management information to the memory card control section 217 through the CPU 213. The memory card control section 217 receives the clip AV stream and the management information and writes them on the memory card 112. Portions (a) through (d) of FIG. 24 show a correlation between the management information files 82 to 84, preferably used in the FAT 32 file system, and the clip AV stream file 85 according to this preferred embodiment. The respective files shown in portions (a) through (d) of FIG. 24 are written on the memory card 112 when a moving picture is recorded continuously using the camcorder 110, for example. This memory card 112 adopts the FAT 32 file system. The storage capacity of the memory card 112 is naturally equal to or greater than the sum of the file sizes of all files.

The management structure of this preferred embodiment has the following two major features.

First of all, the moving picture stream that was shot continuously has been divided into multiple clip AV stream files (02001.m2ts, 02002.m2ts and 02003.m2ts) as shown in portion (d) of FIG. 24. Under the regulations of the FAT 32 file system mentioned above, each clip AV stream file 85 should have a data size of less than 4 GB.

It should be noted that the clip AV streams stored in these clip AV stream files 85 have been given the same STC_id. Also, the ATS values added by the source packetizer 261 (see FIG. 6) change continuously, which means that while a moving picture is being shot continuously, the clock counter 262 and the PLL circuit 263 for generating the ATS are never reset but continue their operations. It does not matter whether multiple clip AV stream files 85 are generated or not.

It should also be noted that the clip AV stream file has not necessarily been split into multiple files right after the moving picture has been recorded. Even if there is only one clip AV stream file right after the recording, multiple clip AV stream files may be generated by editing it, for example. If the management information to be described below is used, the group of moving picture files can be managed integrally even when a plurality of clip AV stream files are generated afterward.

The other major feature is that only one clip information file (02001.clpi) 84 is provided for any number of clip AV stream files as shown in portion (c) of FIG. 24. This clip information file 84 defines a time-address conversion table EP_MAP for the entire clip AV stream. By using this clip information file 84, it can be identified easily in which clip AV stream file 85 the video data to be played back at the specified time is stored and exactly where (i.e., in what source packet) in that clip AV stream file 85 the data is stored.

It should be noted that the conversion table defines the relations between the times and the data locations (addresses) for the entire clip AV stream. That is why it is sufficient to provide only one play item (see FIG. 10) within the playlist file (02001.rpls) 83. The times representing the top and the end of the clip AV stream may be described as the start time (In_time) and the end time (Out_time), respectively, within the play item.

Next, the data structure within the clip information file 84 will be described with reference to FIGS. 25 and 26.

FIG. 25 schematically shows the data structure of the time-address conversion table EP_MAP 87. This conversion table 87 has been drawn up by extending the data structure of the conversion table shown in FIG. 13. More specifically, this conversion table 87 describes not only the correlations between the times (PTS) and the addresses (SPN) but also the names of the files including the source packets. In this conversion table 87, the time stamp (PTS) is also supposed to represent the PTS of each I-picture that is arranged at the top of a GOP compliant with the MPEG standard.

The file names are described in the conversion table 87 because the one clip AV stream has been split into multiple files and stored separately as shown in FIG. 24. That is to say, it cannot be determined, only by reference to the correlation between the given time (PTS) and the source packet number (SPN), exactly in which file the source packet associated with the given PTS is stored.

In this conversion table 87, each of the PTS and SPN values is stored separately in coarse entries and fine entries. However, not every bit is described. Taking a 33-bit PTS as an example, the higher 17 bits out of the 33 bits are described in the coarse entries of the conversion table 87, while the lower 17 bits are described in the fine entries thereof. The 17^{th} bit as counted from the least significant bit is defined for both the coarse entry and the fine entry. However, that bit can be changed arbitrarily during the designing process.

More than one PTS that shares the same coarse entry is regarded as belonging to the group of that coarse entry. Only one coarse entry is described for that group. On the other hand, the fine entry is described for every PTS. That is why every PTS belonging to the same group can be identified by the fine entry.

As for the SPN described above, the coarse entries and the fine entries are provided in quite the same way. In addition, the name of a file, including the source packet that has been given the SPN, is also described in association with the coarse and fine entries. The file name may be described for either every fine entry or every coarse entry of the SPN.

By distributing the respective bits of a PTS to the coarse and fine entries, the data size of the conversion table 87 can be reduced. The process of converting a PTS into a SPN and to which file the source packet, identified by the given SPN, belongs will be described later.

FIG. 26 shows the detailed data structure of the conversion table 87, which can be roughly classified into a first loop 88, a second loop 89 and a third loop 90. The first, second and third loops 88, 89 and 90 are repeated Ne times, Nc times and Nf times, respectively. The Ne, Nc and Nf values are described in a field 91-1.

The first loop 88 corresponds to the file entry to be described later. The first loop 88 is repeated every time at least one of the storage medium, the folder in which the clip AV stream is stored on the single storage medium, and the file name of the clip AV stream changes. In other words, even if the clip AV stream is stored on multiple storage media, multiple folders and/or multiple files, the clip AV stream can also be described using the first loop 88.

The first loop 88 includes a file name field 88-1 and an entry ID field 88-2, for example. The file name of the clip AV stream is described in the file name field 88-1. Thus, even if a single clip AV stream is stored in multiple files, their file names can be described there. In the entry ID field 88-2 on the other hand, described is the fine entry of the first source packet of the clip AV stream included in that file.

The second and third loops 89 and 90 define the correlations between the PTS's and the SPNs, on which a time can be converted into an address and vice versa.

The second loop 89 repeatedly describes the coarse entries of the PTS's and the SPNs. The second loop 89 includes a fine ID field 89-1 and coarse fields 89-2 and 89-3. The fine ID field 89-1 is provided to define at least one fine entry associated with each coarse entry. In the coarse fields 89-2 and 89-3, described are a PTS coarse entry and an SPN coarse entry, respectively.

The third loop 90 repeatedly describes the fine entries of the PTS's and the SPNs. The third loop 90 includes an offset field 90-1 and fine fields 90-2 and 90-3. In the offset field 90-1, an offset value through the end of the I-picture data is stored. In the fine fields 90-2 and 90-3, described are a PTS fine entry and an SPN fine entry, respectively.

Optionally, the first loop 88 may include other fields. For example, a media_ref_id field, describing the serial number of the storage medium to show on which storage medium the clip AV stream file has been recorded, and a BDAV_ref_id field, showing on which BDAV directory the stream file is stored, may be provided. The media_ref_id field is provided because if the recorder can be loaded with multiple different types of storage media at the same time, the split clip AV stream files can be stored on multiple different storage media and therefore the respective storage media need to be identified from each other. Also, the BDAV_ref_id field is provided because a plurality of BDAV directories can be generated for the same storage area (or the same storage medium).

If a clip AV stream has been written as more than one stream file, the file names of the respective stream files and the arrangements of the respective source packets in the clip AV stream are fixed. Then, the CPU 211 can fix the contents of the respective entries of the conversion table 87 described above. The CPU 211 stores the conversion table 87 on the clip information file and then further writes it on the memory card 112.

In recording a digital broadcast, the CPU 211 also generates the conversion table 87. In that case, the processing is performed as follows. First, the CPU 211 analyzes the received transport stream according to the data structure shown in portions (a) through (c) of FIG. 4. Then, the CPU 211 detects a GOP header and an I-picture header from the picture header 42a to find the first I-picture of the GOP and extract the PTS from the PES header 41a-1 at that time. In this manner, the CPU 211 can generate the PTS fine entry in the conversion table 87. On the other hand, when the TS processing section 204 generates a clip AV stream from a transport stream, the CPU 211 can determine on which source packet the data of the first I-picture of the GOP is stored. The CPU 211 can generate an associated SPN fine entry according to the ordinal number of the source packet as counted from the top.

In both of the examples of analog and digital broadcasts described above, even if the operation of writing the clip AV stream has not been actually finished yet, the CPU 211 can also describe the file name of the file, storing that stream, on the conversion table 87. The file name and other additional data of the stream file have already been fixed before the write operation is started.

As described above, according to this preferred embodiment, a series of video data stream is split into a plurality of clip AV stream files. And the respective files are supposed to be stored on multiple storage media and/or in multiple BDAV directories. To perform a playback operation properly even in such a complicated recording mode, the conversion table 87 further includes a status field 91-2.

For example, if the conversion table 87 defines the storage locations of all of those split clip AV stream files, the CPU 211 of the recorder 100 describes “11” in the status field 91-2. On the other hand, if the conversion table 87 defines the storage locations of only some of the clip AV stream files, the CPU 211 describes a value other than “11” in the status field 91-2. The CPU 211 of the recorder 100 can determine whether or not the storage locations of all clip AV stream files are described in the conversion table 87 and therefore can show the result in the status field 91-2. By checking the value in the status field 91-2 during the playback operation, the CPU 211 can determine at least whether or not all video can be played back. The status field 91-2 will be described in further detail later with reference to FIG. 33.

Hereinafter, the procedure of playing back pictures of the clip AV stream by reference to the conversion table 87 will be described with reference to FIG. 27. In the following description, the recorder 100 is supposed to read the clip information file 84, in which the conversion table 87 is stored, the clip AV stream files 85 and so on from the memory card 112 shown in FIG. 24 and then present the pictures based on those files. The management file 82, playlist file 83, clip information file 84 and so on shown in FIG. 24 are supposed to be read by the memory card control section 217 and stored in the RAM 212 when the memory card 112 is loaded into the recorder 100.

FIG. 27 shows the procedure of playing back a picture associated with the specified PTS by reference to the conversion table 87. First, in Step S271, the CPU 211 of the system control section 250 acquires information (PTS) specifying the presentation time of a picture. The PTS specified may be either a PTS value corresponding to the user's specified particular presentation time or a value corresponding to the presentation time of an I-picture during a fast forward playback or rewind playback operation. In this example, the PTS of an I-picture located at the top of a GOP is supposed to have been specified for the sake of simplicity.

The given PTS is divided into the higher 17 bits and the lower 17 bits out of the 33 bits and then processed separately after that.

In Step S272, the CPU 211 refers to the second loop 89 of the time-address conversion table (EP_map_for_one_stream) 87 shown in FIG. 26 with the higher 17 bits of the given PTS value to find the PTS coarse entry 89-2, to which the PTS belongs, and its associated SPN coarse entry 89-3. At the same time, the CPU 211 also finds the value of the fine ID field 89-1, in which information about the ordinal number of the loop to be referred to in the third loop 90 of the table 87 is described.

Next, in Step S273, the CPU 211 refers to the third loop 90 of the table 87 with the detected value of the fine ID field 89-1 to find the PTS and SPN fine entries 90-2 and 90-3 associated with the PTS/SPN coarse entries. As a result, the SPN (coarse and fine entries) associated with the PTS are found.

In Step S274, the CPU 211 finds the name of the file that stores a source packet with the SPN by reference to the SPN fine entry 90-3 and the first loop 88 of the table 87.

More specifically, this processing step is performed as follows. As described above, in the entry ID field 88-2 of the first loop 88, described is the fine entry value of the first source packet of the clip AV stream included in that file. Also, a file name is described in the file name field 88-1 in association with the fine entry 88-2 of the first source packet.

Thus, the CPU 211 determines whether or not the value of the SPN fine entry 90-3 obtained in the previous processing step is equal to or greater than the fine entry value described in the entry ID field 88-2. If these fine entry values are equal to each other, then the CPU 211 gets the file name from the file name field 88-1 associated with the fine entry 88-2 of that SPN. On the other hand, if the former fine entry value is greater than the latter, then the CPU 211 determines whether or not the value of the SPN fine entry 90-3 is equal to or greater than the fine entry value described in the next entry ID field 88-2.

If this processing step is performed repeatedly, the value of the SPN fine entry 90-3 will get equal to or smaller than the fine entry value described in the entry ID field 88-2 at some point in time. When these values get equal to each other, the fine name is gotten just as described above. On the other hand, when the former value gets smaller than the latter value, the file name is gotten from the file name field 88-1 that is defined by the entry ID field preceding the current entry ID field.

As a result, in Step S275, the CPU 211 gives the memory card control section 217 the file name specified and instructs the memory card control section 217 to read one or more source packets that start with the source packet to which the previously detected SPN is allocated. The TS processing section 204 receives the read source packets and sends the transport stream, which has been processed as already described with reference to FIG. 6, to the decoder 206. When the decoder 206 decodes the picture, eventually the picture is output as an analog signal to the TV, for example, and starts to be played back.

By using the clip information file 84 shown in FIGS. 24 to 26, editing can be done by partially deleting the video and it is easy to cope with even a situation where the relation between a file that stores a single moving picture stream and the STC sequence to be stored in that file gets complicated. For example, portions (a) and (b) of FIG. 28 show a clip yet to be edited and an edited clip, respectively, according to this preferred embodiment. There is only one clip information file 84 both before and after the editing.

Hereinafter, the clip information file 84 and the clip AV stream files 85 shown in portion (b) of FIG. 28 will be described in further detail with reference to FIGS. 29 and 30.

Portions (a) through (d) of FIG. 29 show a correlation between the clip information file and the clip AV stream files that have been edited as shown in portion (b) of FIG. 28. In FIG. 29, shown are the first and second clip AV stream files (02001.m2ts and 02002.m2ts) shown in portion (b) of FIG. 28. Hereinafter, it will be described with reference to portions (a) through (d) of FIG. 29 how the CPU 211 generates the time-address conversion table and what data structure the table has.

Portion (a) of FIG. 29 shows the concept of the time-address conversion table that is stored in a single clip information file with respect to the clip AV streams edited. In portion (a) of FIG. 29, the first, second and third rows schematically show the locations of file entries, coarse entries, and fine entries, respectively.

In drawing up such a table, the CPU 211 describes the time-address conversion table on an STC sequence basis. Portion (b) of FIG. 29 shows the respective ranges of two STC sequences. Suppose STC_id #1 has been given to the entire 02001.m2ts stream and a portion of the 02002.m2ts stream through an editing point and STC_id #2 has been given to the remaining portion of the 02002.m2ts stream after the editing point. These are two different STC sequences. Also, portion (c) of FIG. 29 shows two files in which the clip AV streams are stored.

First, the CPU 211 registers file entry #0 with the table in association with the address corresponding to the top of the STC sequence (STC_id #1), i.e., the top of the stream file 02001.m2ts. The file name “02001.m2ts” of the stream file is described in the file entry #0.

While the STC sequence is advancing, the files that store the clip AV stream change from the stream file 02001.m2ts into the stream file 02002.m2ts. Thus, the CPU 211 registers the file entry #1 with the table in association with the address corresponding to the switching point. In the file entry #1, described is the file name “02002.m2ts” of the next stream file.

As shown in the first loop 88 of FIG. 26, the file entries 88-1 and 88-2 are described in association with each other. In this preferred embodiment, each file entry is stored in the first loop 88 in association with the first fine entry of the file specified by the file entry.

Also, according to this preferred embodiment, under the restrictions of the FAT 32 file system, the clip AV stream to which STC_id #1 is allocated is stored in a plurality of files 02001.m2ts and 02002.m2ts. That is why the clip AV stream stored in these files should be able to be played back continuously without a break.

To guarantee such continuous playback, according to this preferred embodiment, the ATS values stored in the headers 74 of the respective source packets of the clip AV stream change continuously and periodically. In other words, the ATS values change periodically without a break. Portion (d) of FIG. 29 shows how the ATS values of the clip AV stream change in multiple files. It can be understood that the ATS values are continuous even at the switching point where the 02001.m2ts file changes into the 02002.m2ts file.

In the prior art, whenever files change, STC_id of the clip AV stream is supposed to change, too. That is why the TS processing section 204 and the decoder 206 reset the processors once in analyzing clip AV streams from different files. As a result, the buffer in which the reference pictures in the decoder 206 are temporarily stored is also cleared and the video to play back discontinues.

However, according to this preferred embodiment, the CPU 211 does not reset the processors of the TS processing section 204 and the decoder 206 when the files change. The clock counter 262, the PLL circuit 263 and so on of the TS processing section 204 continue to operate even after the files have changed. As a result, the clock counter 262 outputs continuously changing timing information and the source depacketizer 265 sends the TS packets to the decoder 206 based on that signal and the ATS. Consequently, even if the clip AV stream is stored in multiple files separately, the video can still be played back without a break based on the ATS values of the stream.

The CPU 211 can determine, by reference to the description of the file entry, whether or not the processors of the TS processing section 204 should be reset. In reading the file specified by the file entry, the CPU 211 does not reset the processors because the presence of the file entry means that a single clip AV stream has been split into multiple files and stored separately in those files. However, if the file entry #0 has been added, it means that a new stream should begin, and therefore, the processors may be reset.

On the other hand, at a point where STC_id #1 changes into STC_id #2 (e.g., at the editing point), the ATS values are discontinuous. In that case, there is no need to guarantee continuous video playback. Also, to the stream to which STC_id #2 has been allocated, the storage file name “02002.m2ts” is added again to its file entry #0. That is why in playing back video from this stream, the TS processing section 204, the decoder 206 and so on are reset.

In the foregoing description, the fine entries are supposed to be set with respect to the PTS of each I-picture located at the top of a GOP and the PTS of such an I-picture is supposed to be specified as the presentation start time. In general, however, the presentation start time (PTS) of a non-I-picture is specified. Hereinafter, it will be described that the presentation may be started with an arbitrary picture using the fine entries.

FIG. 30 shows a correlation between fine entries and I-pictures located at the respective tops of GOPs. Hereinafter, it will be described how to present the last B-picture 301 within a GOP (N−1). The picture associated with the presentation start time (PTS) specified is the B-picture 301.

It should be noted that the GOP (N−1) stored covers two clip AV stream files 02001.m2ts and 02002.m2ts and that the data of the B-picture 301 is stored in the 02002.m2ts file.

First, on acquiring the PTS, the CPU 211 finds the PTS coarse entry 89-2 and its associated SPN coarse entry 89-3 and fine ID field 89-1 by using the higher 17 bits of the PTS. Next, by reference to the value of the fine ID field 89-1 just found, the CPU 211 finds PTS and SPN fine entries 90-2 and 90-3 associated with the PTS/SPN coarse entries. In this example, the fine entry (N−1) shown in FIG. 30 is supposed to be obtained as the PTS fine entry.

The CPU 211 compares the PTS fine entry obtained to the lower 17 bits of the given PTS to find the latter greater than the former. Then, the CPU 211 reads the next fine entry (i.e., the PTS fine entry N in FIG. 30) that follows the current PTS fine entry from the third loop 90 of the time-address conversion table 87 and compares the PTS fine entry to the lower 17 bits of the given PTS to find the latter smaller than the former.

This result of comparison shows that the given PTS is greater than the first I-picture of the GOP (N−1) but smaller than that of the GOP (N). Consequently, it can be seen that the picture associated with the PTS specified is included in the GOP (N−1).

In this case, to start playback with the first I-picture of the GOP (N−1), the 02001.m2ts file that stores the data of that I-picture needs to be found. However, the procedure of the finding process is just as already described with reference to FIG. 27 and the description thereof will be omitted herein.

The decoder 206 may sequentially decode the respective pictures, starting with the first I-picture, of the GOP (N−1). And when a picture, of which the PTS agrees with the PTS specified (i.e., the B-picture 301), comes up, the decoder 206 may start outputting the B-picture 301 and the pictures that follow it. The processing described above may be performed on an arbitrary picture.

By drawing up a table (or list) that associates the presentation time of a predetermined picture, the storage address and the file entry with each other just like the time-address conversion table 87 of this preferred embodiment, search can be completed just as intended, no matter what correlation the storage media, the AV stream files and STC sequences have.

In the example described above, the four types of fields, including media_ref_id field, BDAV_ref_id field, Clip_AV_stream_file_name field and first_fine_entry_ref_id field, are provided for the file entry (i.e., the first loop 88) shown in FIG. 26. However, the fields to define may be changed.

FIG. 31(a) through 31(d) show other exemplary data structures of fine entries. Various types of information may be described instead of the fine entries of the first source packet in the file entry (i.e., the first loop 88) shown in FIG. 26. Specifically, FIG. 31(a) shows a field 88a that defines the first coarse entry and the last coarse entry. FIG. 31(b) shows a field 88b that defines the first fine entry and the last fine entry. FIG. 31(c) shows a field 88c that defines the first coarse entry and the number of sets of coarse entries. And FIG. 31(d) shows a field 88d that defines the first fine entry and the number of sets of fine entries.

In the preferred embodiment described above, the file entries are supposed to be added. Alternatively or additionally, part or all of the information defined as the file entries (i.e., media_ref_id, BDAV_ref_id and Clip_AV_stream_file_name described above) may be stored in either the coarse entry (i.e., the second loop 89 shown in FIG. 26) or the fine entries (i.e., the third loop 90 shown in FIG. 26).

Optionally, a file entry, equivalent to the file entry described above, may be added to a time map TMAP compliant with the DVD Video Recording standard. For example, FIG. 32 shows an extended time map TMAP including fine entries 32, time entries 33 and VOBU entries 34. To obtain such information, the information about the coarse entries (i.e., the second loop 89) shown in FIG. 26 (including the modified examples shown in FIGS. 31(a) through 31(d)) may be replaced with Time entry and the information about the fine entries (i.e., the first loop 88) may be replaced with VOBU entries.

In the preferred embodiment described above, the file entry is also supposed to be added to the time map TMAP. Alternatively or additionally, part or all of the information defined as the file entry (i.e., media_ref_id, BDAV_ref_id and Clip_AV_stream_file_name described above) may be stored in either the Time entry 33 or the VOBU entry 34 itself. Optionally, a field that stores information equivalent to the status field 91-2 shown in FIG. 26 may be provided as well.

In the preferred embodiment described above, a number of clip AV stream files are supposed to be stored in the memory card 112 as shown in FIG. 24. Alternatively, these files may be stored in mutually different storage media. Hereinafter, a modified example will be described with reference to FIG. 33.

Portion (a) of FIG. 33 shows the range of “one shot” in which a moving picture has been shot continuously. Portion (b) of FIG. 33 shows the concept of content's management information and clips including stream data. One shot, i.e., a single content, can be split into multiple clips a, b and c, which may be stored in respective memory cards 112a, 112b and 112c separately. Alternatively, a one shot may be complete within a single clip as well. Each clip includes clip meta-data 331, a time map 332 and a part of the clip AV stream 333 (i.e., a partial stream). The clip AV stream 333 is made up of three partial streams 333a, 333b and 333c, which are included in the clips a, b and c, respectively. Three clips a, b and C are shown in portion (b) of FIG. 33. However, since these clips have the same structure, only the clip a will be described herein as an example. For the sake of simplicity, the partial stream 333a will be referred to herein as “partial stream a”, for example.

The clip a includes clip meta-data a, time map a and partial stream a. The clip meta-data a and the time map a are pieces of management information, while the partial stream a forms an integral part of the clip AV stream 333. This data corresponds to the clip AV stream file 85 (e.g., 02001.m2ts) shown in portion (d) of FIG. 24.

The clip meta-data a is described in the XML format and defines information that is required to play back a content (such as the video and/or audio format(s)). The clip meta-data a will be described in further detail later with reference to FIG. 34.

The time map a is a table that defines correspondence between the presentation times and their storage locations (addresses) on a playback unit basis. This time map will be referred to herein as a “clip time line (ClipTimeLine)” and a file that stores the clip time line is shown with an extension “CTL”. The time map a is the same as the time-address conversion table (EP_map_for_one_stream) 87 shown in FIG. 26 or the time map TMAP shown in FIG. 32.

It should be noted that the clip meta-data and the time map are not only ones but are provided for their associated partial stream file in the example shown in FIG. 33. However, the time maps a, b and c are actually the same piece of information. Suppose three card slots are provided for the recorder 100 shown in FIG. 5 and are loaded with the memory cards 112a, 112b and 112c, respectively, to perform write processing. When the recorder 100 has finished writing the partial stream files a, b and c sequentially on the memory cards 112a, 112b and 112c, respectively, the contents of the time maps will be fixed. Then, the recorder 100 may write the time maps on the memory cards 112a, 112b and 112c, respectively. As the time maps define the storage locations of all stream files, the status field 91-2 has a value “11” indicating that status.

When the respective memory cards 112a, 112b and 112c are loaded into the device for playback purposes, the playback can be started from any picture on any storage medium by using these time maps. Supposing the time maps a, b and c are the time-address conversion table 87 shown in FIG. 26, the CPU of that device knows, by reference to the status field 91-2, that the storage locations of all stream files are defined in the respective time maps a, b and c. Furthermore, once the presentation start time (PTS) has been specified, the CPU can find, by that PTS, not only on which memory card the data of the picture to present is stored but also the file name of the stream file that stores the data, no matter which memory card the time map used belongs to. At this point in time, the media_ref_id field and the file name field 88-1 in the first loop 88 of the time map are referred to.

It should be noted that the memory card specified could have been unloaded from the device. In that case, the CPU of that device may notify the user of information that identifies the memory card (e.g., a memory card name). Furthermore, since the file name of the stream file has also been given, an alert such as “insert memory card yyy storing file with file name xxx” may be shown on the TV screen, for example.

In the example of this preferred embodiment, if the respective memory cards had a capacity of 4 gigabytes and if the files sizes of the respective partial streams were equal to the maximum permissible file size (of 4 gigabytes) according to the FAT 32 file system, then no spaces would be left in any of the memory cards 112a, 112b and 112c and the management information could not be written on the memory cards 112 anymore. That is why the file sizes of the respective partial streams should be less than 4 gigabytes. Furthermore, the partial stream may be supposed to include an integral number of source packets and have a size that is less than 4 gigabytes, which is the maximum permissible size according to the file system, and that is an integral number of times as large as the size of a source packet (of 192 bytes).

Within a single shot, the identification information of the system time clock (STC_id) of the clip AV stream 333 does not change and the arrival time stamps ATS are also continuous as shown in portion (d) of FIG. 29. This relation is maintained even if the clip AV stream 333 has been split into multiple partial streams a, b and c. Thus, the STC_id values of the respective partial streams agree with each other and the ATS values change continuously before and after the boundary between two continuous partial streams. Even if the files change while the partial stream a, b or c is being played back, the clock counter 262 (see FIG. 6) of the ATS is never reset or no value irrelevant to preceding counts is set, either. Instead, the clock counter 262 (see FIG. 6) continues counting with respect to the predetermined reference time and outputting count values.

Portion (c) of FIG. 33 shows the three memory cards 112a, 112b and 112c. The data files of the respective clips a, b and c are written on the memory cards 112a, 112b and 112c, respectively.

FIG. 34 shows the contents of information included in the clip meta-data 331, which is classified into the two types of data: “Structural” data and “Descriptive” data.

The “Structural” data includes descriptions of clip name, essence list and relation information. The clip name is a piece of information that identifies the given file and a known unique material identifier (UMID) may be described as the clip name, for example. The UMID may be generated as a combination of the time when the content was produced and the media access control (MAC) address of the device that produced it. Furthermore, the UMID is also generated in view of whether the content has been newly produced or not. That is to say, if a content has been given a UMID once but has been edited or processed after that, a different value from the UMID of the original content is added to that content. That is why if UMIDs are used, mutually different values can be defined for all sorts of contents around the world, and therefore, any content can be identified uniquely.

The essence list includes descriptions of information that is required to decode video and audio (i.e., video information and audio information). For example, the video information includes descriptions of the format, compression coding method and frame rate of video data, while the audio information includes descriptions of the format and sampling rate of audio data. In this preferred embodiment, the compression coding method is compliant with the MPEG-2 standard.

The relation information defines a relation between clips in a situation where there are a number of clips a to c as in portion (b) of FIG. 33. More specifically, the relation information defines in what order the clip AV stream (or the partial streams), consisting of those clips, should be presented, i.e., the presentation order of the clip AV stream. These pieces of information are managed as connection information 340. As the connection information 340, a piece of information identifying the first clip of that shot, a piece of information showing the clip name of the previous clip, and a piece of information showing the clip name of the next clip are described. Those pieces of information showing the clip names are defined by the UMID and the unique serial number of that memory card 112.

The Descriptive data includes access information, device information, and shooting information. The access information includes descriptions of the person who updated the clip last time and the date and time of the update. The device information includes descriptions of the name of the manufacturer and the serial number and the model of the recorder. The shooting information includes the name of the shooter, the shooting start date and time, the end date and time, and the location.

In the example shown in FIG. 33, the respective time maps a, b and c are supposed to be the same piece of information. However, those time maps may be different pieces of information as well. Imaginable time map allocations (1) through (4) are as follows:

(1) A single time map may be provided for each partial stream (e.g., a time map x may be used only to play back a partial stream x). According to this time map allocation, if the first time map accessed included no description of the presentation time stamp (PTS) specified, then the clips to search should be changed into either the next clip or the previous clip by reference to the relation information described above and the time map of that clip should be referred to.

(2) A time map may be provided for every partial stream that has been recorded so far (e.g., a time map x may be used to play back partial streams that start with the first partial stream 0 and end with the partial stream x). According to this time map allocation, if the picture data associated with the presentation time stamp (PTS) specified is included in any of the partial streams that have been generated so far, the memory card and the file name including that data can be identified by reference to that time map. However, if that data is not included in any of those partial streams, the clips to search should be changed into the next one by reference to the relation information and the time map should be referred to in that clip.

(3) A time map may be generated by defining additional information that identifies the partial stream to be recorded next and its associated time map (e.g., the file names of the next partial stream and its associated time map) for the time map of (2). In that case, a time map x may be used to play back partial streams that start with the first partial stream 0 and end with the partial stream x. In addition, the time map x may also be used to access the next partial stream (x+1). If this time map is used, not just can the advantages described for (2) be achieved but also can the next partial stream file and its associated time map be found without reference to the relation information. As a result, the access can be accelerated.

(4) A time map may be provided for all partial streams (i.e., a time map x may be used to play back every partial stream). This time map allocation is the same as what has already been described with reference to FIG. 33. In that case, the time maps stored in the respective memory cards are identical with each other.

If the status field 91-2 described above is used, it can be seen in which of these four allocations (1) through (4) the time map(s) is/are recorded on the memory cards. For example, the status field 91-2 may have a value “00” to represent the time map (1), a value “01” to represent the time map (2), a value “10” to represent the time map (3), and a value “11” to represent the time map (4), respectively. According to the value of this status field 91-2, the CPU of the device may switch the modes of processing in making reference to the respective files from the presentation time (PTS) specified.

The data processing of the present invention described above is naturally realized by getting a predetermined program executed by a computer. That program may be stored in a flexible disk, a hard disk, an optical disk or any other computer-readable information storage medium.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

### INDUSTRIAL APPLICABILITY

A data processor according to the present invention generates a table (access map) that always has an integral description, no matter what relation the storage medium and its files or a stream and its file have. In this access map, stored are information identifying a stream's file, information about a storage medium that stores the file, and/or information about a folder that includes the file. As a result, if this access map is used, there is no need for the data processor to understand how part or all of the stream is stored by analyzing the stream. Also, by using this access map, any desired playback point of the stream can be accessed easily.

1. A data processor for writing a data stream, representing video, and management information for playing back the video based on the data stream on at least one storage medium,
wherein in the data stream, picture data of respective pictures forming the video and time information, showing presentation times of the respective pictures, are stored in association with each other, and
wherein the data processor comprises:
a processor for generating, as the management information, a table that associates the time information, storage locations of the picture data in the data stream, and file information identifying a stream file to store the picture data with each other for one or more pictures, and
a controller for writing the data stream and the management information as one or more stream files and as one or more management information files, respectively, on the storage medium.

2. The data processor of claim 1, wherein the controller generates a plurality of stream files and one management information file.

3. The data processor of claim 2, wherein the data stream includes at least one playback unit beginning with base picture data of a base picture that is decodable by itself, and
wherein the processor generates the table for the base picture data at the top of the playback unit.

4. The data processor of claim 3, wherein the processor generates the table for the base picture data that is arranged at the top of each of the stream files.

5. The data processor of claim 2, wherein the data stream includes the time information that has been generated with respect to a common reference time for the video that has been recorded continuously, and
wherein the controller splits the data stream that has been generated with respect to the common reference time, thereby generating a plurality of stream files.

6. The data processor of claim 1, wherein the data stream is made up of a plurality of packets, each having a constant data length, and
wherein the processor finds the storage location of the picture data by reference to the arrangement of the packets in the data stream.

7. The data processor of claim 1, wherein the controller writes the one or more stream files and the one or more management information files on the storage medium that adopts FAT 32 file system.

8. The data processor of claim 3, further comprising an encoder for generating the at least one playback unit based on an analog signal.

9. The data processor of claim 5, further comprising an encoder for generating the data stream with respect to the common reference time when video is recorded continuously based on an analog signal.

10. A storage medium having stored thereon one or more stream files, including a data stream representing video, and one or more management information files that store management information for playing back the video based on the data stream,
wherein in the data stream, picture data of respective pictures forming the video and time information, showing presentation times of the respective pictures, are stored in association with each other, and
wherein in the management information, stored is a table that associates the time information, storage locations of the picture data in the data stream, and file information identifying the stream file to store the picture data with each other for one or more pictures.
